(19) United States
(12) Patent Application Publication
(10) Pub. No.: US 2021/0403282 A1
(43) Pub. Date: Dec. 30, 2021

(54) PASSENGER GUIDANCE DEVICE AND PASSENGER GUIDANCE METHOD

(71) Applicant: Mitsubishi Electric Corporation, Tokyo (JP)

(72) Inventors: Miki ARAI, Tokyo (JP); Kei KASUGA, Tokyo (JP); Takayasu HASHIMOTO, Tokyo (JP); Thibaud GENTIL, Tokyo (JP)

(73) Assignee: Mitsubishi Electric Corporation, Tokyo (JP)

(21) Appl. No.: 17/474,048

(22) Filed: Sep. 14, 2021

Related U.S. Application Data
(63) Continuation of application No. PCT/JP2019/016165, filed on Apr. 15, 2019.

(51) Int. Cl. B66B 3/00; G06K 9/00; G06T 7/70; G06T 7/20; G06T 13/80; G05D 1/02; B66B 5/00

(52) U.S. Cl. CPC B66B 3/006; G06K 9/00369; G06K 9/00771; G06T 7/70; G06T 7/20; B66B 2201/4615; G05D 1/0276; B66B 5/0012; G06T 2207/30196; G06T 2207/30232; B66B 2201/103; G06T 13/80

(57) ABSTRACT

A passenger guidance device is configured to include: a passenger detection unit for detecting a passenger who has entered a boarding waiting area which is an area in front of an entrance door of an elevator; a position detection unit for detecting a position of a passenger detected by the passenger detection unit; a number assignment unit for assigning a number indicating a boarding order to the elevator to the passenger detected by the passenger detection unit every time the passenger detection unit detects a passenger; and a number display unit for displaying the number assigned by the number assignment unit on a floor surface around the position detected by the position detection unit.

### CROSS-REFERENCE TO RELATED APPLICATION

The present application is based on PCT filing PCT/JP2019/016165, filed Apr. 15, 2019, the entire contents of which are incorporated herein by reference.

### TECHNICAL FIELD

The present invention relates to a passenger guidance device and a passenger guidance method for displaying the number indicating a boarding order to an elevator on a floor surface around a position of a passenger.

### BACKGROUND ART

Patent Literature 1 below discloses a landing guide device including a projector that displays a position where a passenger waits until an elevator arrives.

Further, the projector disclosed in Patent Literature 1 displays a boarding guidance path for guiding a passenger into an elevator.

### CITATION LIST

### Patent Literature

Patent Literature 1: JP 2015-218015A

### SUMMARY OF INVENTION

### Technical Problem

The landing guide device disclosed in Patent Literature 1 displays a position where a passenger waits and displays a boarding guidance path, but does not display the boarding order to the elevator of the passenger waiting for arrival of the elevator. Therefore, there is a problem that passengers waiting for the arrival of the elevator cannot recognize the boarding order to the elevator.

The present invention has been made to solve the above-described problem, and an object of the present invention is to provide a passenger guidance device and a passenger guidance method capable of allowing a passenger waiting for arrival of an elevator to recognize a boarding order to the elevator.

### Solution to Problem

A passenger guidance device according to the present invention includes comprising processing circuitry to detect a passenger who has entered a boarding waiting area which is an area in front of an entrance door of an elevator, to detect a position of a passenger detected by the processing circuitry, to assign a number indicating a boarding order to the elevator to a passenger detected by the processing circuitry every time the processing circuitry detects a passenger, and to display the number assigned by the processing circuitry on a floor surface around the position detected by the processing circuitry.

### Advantageous Effects of Invention

According to the present invention, the passenger guidance device is configured to include processing circuitry to assign a number indicating a boarding order to the elevator to a passenger detected by the processing circuitry every time the processing circuitry detects a passenger, and to display the number assigned by the processing circuitry on a floor surface around the position detected by the processing circuitry. Therefore, the passenger guidance device according to the present invention can allow passengers waiting for the arrival of the elevator to recognize the boarding order to the elevator.

### BRIEF DESCRIPTION OF DRAWINGS

FIG. 1 is a configuration diagram illustrating a passenger guidance device according to a first embodiment.

FIG. 2 is a hardware configuration diagram illustrating hardware of a signal processing unit 12 in the passenger guidance device according to the first embodiment.

FIG. 3 is an explanatory diagram illustrating an entrance door 1 of an elevator and a boarding waiting area 2 for passengers.

FIG. 4 is a hardware configuration diagram of a computer when the signal processing unit 12 is implemented by software, firmware, or the like.

FIG. 5 is a flowchart illustrating a passenger guidance method which is a processing procedure performed in the signal processing unit 12.

FIG. 6 is an explanatory diagram illustrating a passenger 40 who has entered the boarding waiting area 2.

FIG. 7 is an explanatory diagram illustrating registered contents of a passenger registration unit 17.

FIG. 8 is an explanatory diagram illustrating registered contents of the passenger registration unit 17.

FIG. 9 is an explanatory diagram illustrating registered contents of the passenger registration unit 17.

FIG. 10 is an explanatory diagram illustrating numbers displayed on a floor surface around positions of passengers 40.

FIG. 11A is an explanatory diagram illustrating an example of guidance information prompting movement of a passenger 40 from a position of the passenger 40 having an ID of assignment number=1 to an entrance door 1, FIG. 11B is an explanatory diagram illustrating an example of guidance information prompting movement of a passenger 40 from a position of the passenger 40 having an ID of assignment number=2 to the entrance door 1, and FIG. 11C is an explanatory diagram illustrating an example of guidance information prompting movement of a passenger 40 from a position of the passenger 40 having an ID of assignment number=3 to the entrance door 1.

FIG. 12 is a configuration diagram illustrating a passenger guidance device according to a third embodiment.

FIG. 13 is an explanatory diagram illustrating entrance doors 1-1 and 1-2 of two elevators and boarding waiting areas 2-1 and 2-2 of the two elevators.

FIG. 14A is an explanatory diagram illustrating registered contents of a passenger registration unit 55 related to a passenger 40 who has entered the boarding waiting area 2-1, and FIG. 14B is an explanatory diagram illustrating registered contents of the passenger registration unit 55 related to a passenger 40 who has entered the boarding waiting area 2-2.

FIG. 15A is an explanatory diagram illustrating registered contents of the passenger registration unit 55 related to the passenger 40 who has entered the boarding waiting area 2-1, and FIG. 15B is an explanatory diagram illustrating registered contents of the passenger registration unit 55 related to the passenger 40 who has entered the boarding waiting area 2-2.

FIG. 16A is an explanatory diagram illustrating registered contents of the passenger registration unit 55 related to the passenger 40 who has entered the boarding waiting area 2-1, and FIG. 16B is an explanatory diagram illustrating registered contents of the passenger registration unit 55 related to the passenger 40 who has entered the boarding waiting area 2-2.

FIG. 17 is an explanatory diagram illustrating numbers displayed on the floor surface around positions of passengers 40.

FIG. 18 is a configuration diagram illustrating a passenger guidance device according to a fourth embodiment.

FIG. 19 is a hardware configuration diagram illustrating hardware of a signal processing unit 12 in the passenger guidance device according to the fourth embodiment.

FIG. 20 is an explanatory diagram illustrating the entrance doors 1-1 and 1-2 of two elevators and the boarding waiting areas 2-1 and 2-2 of the two elevators.

FIG. 21 is a configuration diagram illustrating a passenger guidance device according to a fifth embodiment.

FIG. 22 is a hardware configuration diagram illustrating hardware of a signal processing unit 12 in the passenger guidance device according to the fifth embodiment.

FIG. 23 is an explanatory diagram illustrating the entrance doors 1-1 and 1-2 of two elevators and the boarding waiting areas 2-1 and 2-2 of the two elevators.

FIG. 24 is a configuration diagram illustrating a passenger guidance device according to a sixth embodiment.

FIG. 25 is a hardware configuration diagram illustrating hardware of a signal processing unit 12 in the passenger guidance device according to the sixth embodiment.

FIG. 26 is an explanatory diagram illustrating the entrance doors 1-1 and 1-2 of two elevators and the boarding waiting areas 2-1 and 2-2 of the two elevators.

FIG. 27 is an explanatory diagram illustrating guidance information displayed on a floor surface around positions of passengers 40.

FIG. 28 is a configuration diagram illustrating a passenger guidance device according to an eighth embodiment.

FIG. 29 is a hardware configuration diagram illustrating hardware of a signal processing unit 12 in the passenger guidance device according to the eighth embodiment.

FIG. 30 is an explanatory view illustrating rounds displayed on the floor surface around the positions of passengers 40.

FIG. 31 is a configuration diagram illustrating a passenger guidance device according to a ninth embodiment.

FIG. 32 is a hardware configuration diagram illustrating hardware of a signal processing unit 12 in the passenger guidance device according to the ninth embodiment.

FIG. 33 is an explanatory view showing that an area including both a passenger 40 and a movable object is a personal space.

FIG. 34 is a configuration diagram illustrating a passenger guidance device according to a tenth embodiment.

FIG. 35 is a hardware configuration diagram illustrating hardware of a signal processing unit 12 in the passenger guidance device according to the tenth embodiment.

FIG. 36 is an explanatory view showing that an area including a movable object is a personal space.

FIG. 37 is an explanatory diagram illustrating assignment numbers displayed at a plurality of locations on the floor surface around the position of the passenger 40.

FIG. 38A is an explanatory diagram illustrating a display position of an assignment number at time t₁, FIG. 38B is an explanatory diagram illustrating a display position of the assignment number at time t₁+t₀ when time to has elapsed from time t₁, and FIG. 38C is an explanatory diagram illustrating a display position of the assignment number at time t₁+2t₀ when time to has elapsed from time t₁+t₀.

FIG. 39 is a configuration diagram illustrating a passenger guidance device according to a thirteenth embodiment.

FIG. 40 is a hardware configuration diagram illustrating hardware of a signal processing unit 12 in the passenger guidance device according to the thirteenth embodiment.

### DESCRIPTION OF EMBODIMENTS

Hereinafter, in order to explain this invention in more detail, some modes for carrying out the invention will be described with reference to the accompanying drawings.

### First Embodiment

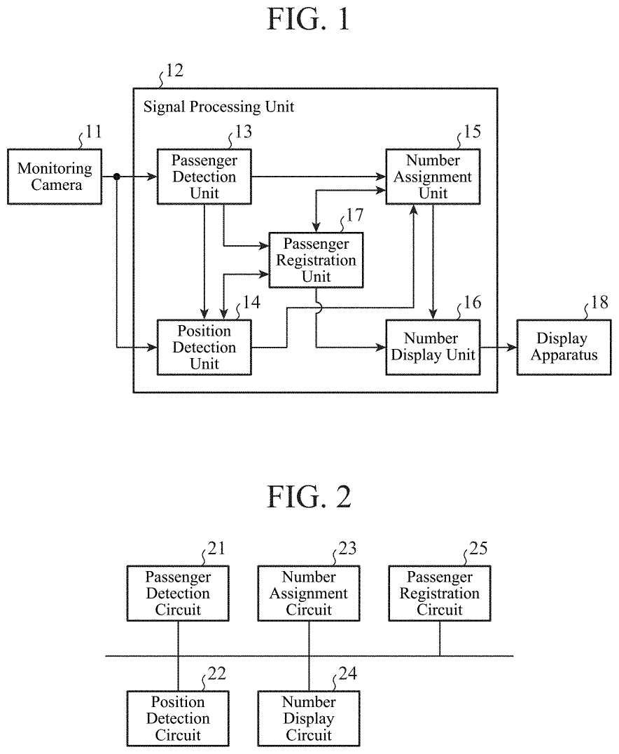

FIG. 1 is a configuration diagram illustrating a passenger guidance device according to the first embodiment.

FIG. 2 is a hardware configuration diagram illustrating hardware of a signal processing unit 12 in the passenger guidance device according to the first embodiment.

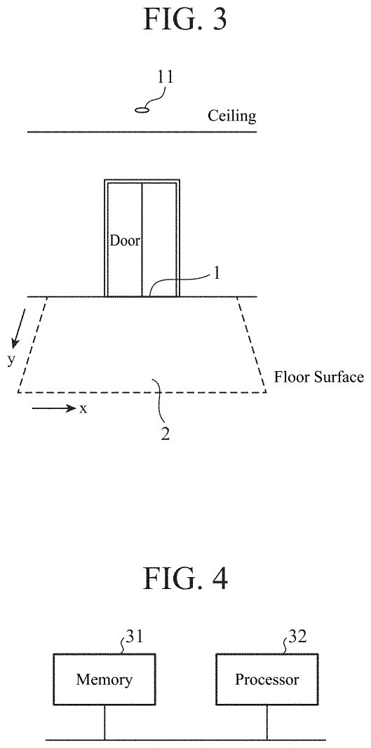

FIG. 3 is an explanatory diagram illustrating an entrance door 1 of an elevator and a boarding waiting area 2 for a passenger 40 (see FIG. 6).

In FIG. 3, the entrance door 1 of the elevator is an entrance of the elevator, and the position of the entrance door 1 is a position where a door of the elevator is installed.

The boarding waiting area 2 is an area in front of the entrance door 1 of the elevator, and is a space where a plurality of passengers 40 can wait.

The x direction is a direction parallel to the entrance door 1 on a floor surface in the boarding waiting area 2, and the y direction is a direction orthogonal to the entrance door 1 on the floor surface in the boarding waiting area 2.

A monitoring camera 11 is installed on the ceiling.

The monitoring camera 11 captures an image of an area including the boarding waiting area 2, and outputs image data of the area including the boarding waiting area 2 to the signal processing unit 12.

In the passenger guidance device illustrated in FIG. 1, the monitoring camera 11 is installed on the ceiling. However, this is merely an example, and the monitoring camera 11 may be installed on a wall, for example.

In FIG. 1, the signal processing unit 12 includes a passenger detection unit 13, a position detection unit 14, a number assignment unit 15, a number display unit 16, and a passenger registration unit 17.

The passenger detection unit 13 is implemented by, for example, a passenger detection circuit 21 illustrated in FIG. 2.

The passenger detection unit 13 analyzes the image data output from the monitoring camera 11 to detect a passenger 40 who has entered the boarding waiting area 2.

The passenger detection unit 13 outputs a detection signal K_{ID} indicating that the passenger 40 is detected to each of the position detection unit 14 and the number assignment unit 15. The detection signal K_{ID} includes an identification (ID) of the detected passenger 40.

Further, the passenger detection unit 13 registers the ID of the detected passenger 40 in the passenger registration unit 17.

In the passenger guidance device illustrated in FIG. 1, the passenger detection unit 13 analyzes the image data output from the monitoring camera 11 to detect the passenger 40 who has entered the boarding waiting area 2. However, this is merely an example, and if the passenger detection unit 13 is implemented by, for example, an object detection sensor or a human sensor, the passenger detection unit 13 can detect the passenger 40 who has entered the boarding waiting area 2 using an ultrasonic wave or the like emitted by the passenger detection unit 13.

The position detection unit 14 is implemented by, for example, a position detection circuit 22 illustrated in FIG. 2.

The position detection unit 14 analyzes the image data output from the monitoring camera 11 to detect a position of the passenger 40 detected by the passenger detection unit 13.

The position detection unit 14 registers the position of the passenger 40 who has entered the boarding waiting area 2 in the passenger registration unit 17 so as to correspond to the ID included in the detection signal K_{ID} output from the passenger detection unit 13.

Every time image data is output from the monitoring camera 11, the position detection unit 14 analyzes the image data, and performs tracking processing for all passengers 40 whose IDs are registered in the passenger registration unit 17, thereby detecting positions of all passengers 40 after the movement.

The position detection unit 14 updates the positions of all passengers 40 associated with the IDs registered in the passenger registration unit 17 to the positions after the movement.

The number assignment unit 15 is implemented by, for example, a number assignment circuit 23 illustrated in FIG. 2.

Every time the passenger 40 is detected by the passenger detection unit 13, the number assignment unit 15 assigns a number indicating a boarding order to the elevator to the passenger 40 detected by the passenger detection unit 13.

For example, the number assignment unit 15 assigns the number=1 to a passenger 40 who has firstly entered the boarding waiting area 2, assigns the number=2 to a passenger 40 who has secondly entered the boarding waiting area 2, and assigns the number=3 to a passenger 40 who has thirdly entered the boarding waiting area 2.

The number assignment unit 15 registers each assignment number, which is a number assigned to the passenger 40 detected by the passenger detection unit 13, in the passenger registration unit 17 so as to correspond to an ID included in the detection signal K_{ID} output from the passenger detection unit 13.

The number display unit 16 is implemented by, for example, a number display circuit 24 illustrated in FIG. 2.

The number display unit 16 acquires the assignment number associated with an ID registered in the passenger registration unit 17 and the position associated with the ID registered in the passenger registration unit 17.

The number display unit 16 generates display data for displaying the assignment number associated with the ID on the floor surface around the position associated with the ID.

The number display unit 16 outputs the generated display data to a display apparatus 18.

The passenger registration unit 17 is implemented by, for example, a passenger registration circuit 25 illustrated in FIG. 2.

The passenger registration unit 17 registers the ID, the position, and the assignment number of the passenger 40 who has entered the boarding waiting area 2.

The display apparatus 18 is implemented by, for example, a projector.

The display apparatus 18 displays the number assigned by the number assignment unit 15 on the floor surface around the position detected by the position detection unit 14 in accordance with the display data output from the number display unit 16.

In the passenger guidance device illustrated in FIG. 1, the display apparatus 18 is implemented by the projector. However, this is merely an example, and the display apparatus 18 may be implemented by a group of light emitting diodes (LEDs) laid on the floor surface.

In FIG. 1, it is assumed that each of the passenger detection unit 13, the position detection unit 14, the number assignment unit 15, the number display unit 16, and the passenger registration unit 17, which are components of the signal processing unit 12, is implemented by dedicated hardware as illustrated in FIG. 2. That is, it is assumed that the signal processing unit 12 is implemented by the passenger detection circuit 21, the position detection circuit 22, the number assignment circuit 23, the number display circuit 24, and the passenger registration circuit 25.

The passenger registration circuit 25 is implemented by, for example, a nonvolatile or volatile semiconductor memory, such as a RAM (Random Access Memory), a ROM (Read Only Memory), a flash memory, an EPROM (Erasable Programmable Read Only Memory), and an EEPROM (Electrically Erasable Programmable Read Only Memory), a magnetic disk, a flexible disk, an optical disk, a compact disk, a mini disk, a DVD (Digital Versatile Disc), or the like.

Each of the passenger detection circuit 21, the position detection circuit 22, the number assignment circuit 23, and the number display circuit 24 is implemented by, for example, a single circuit, a composite circuit, a programmed processor, a parallel-programmed processor, an application specific integrated circuit (ASIC), a field-programmable gate array (FPGA), or a combination thereof.

The components of the signal processing unit 12 are not limited to those implemented by dedicated hardware, but the signal processing unit 12 may be implemented by software, firmware, or a combination of software and firmware.

The software or firmware is stored in a memory of a computer as a program. The computer means hardware that executes a program, and is implemented by, for example, a central processing unit (CPU), a central processing unit, a processing unit, an arithmetic unit, a microprocessor, a microcomputer, a processor, or a digital signal processor (DSP).

FIG. 4 is a hardware configuration diagram of a computer when the signal processing unit 12 is implemented by software, firmware, or the like.

In a case where the signal processing unit 12 is implemented by software, firmware, or the like, the passenger registration unit 17 is configured on a memory 31 of the computer. A program for causing a computer to execute processing procedures performed in the passenger detection unit 13, the position detection unit 14, the number assignment unit 15, and the number display unit 16 is stored in the memory 31. Then, a processor 32 of the computer executes the program stored in the memory 31.

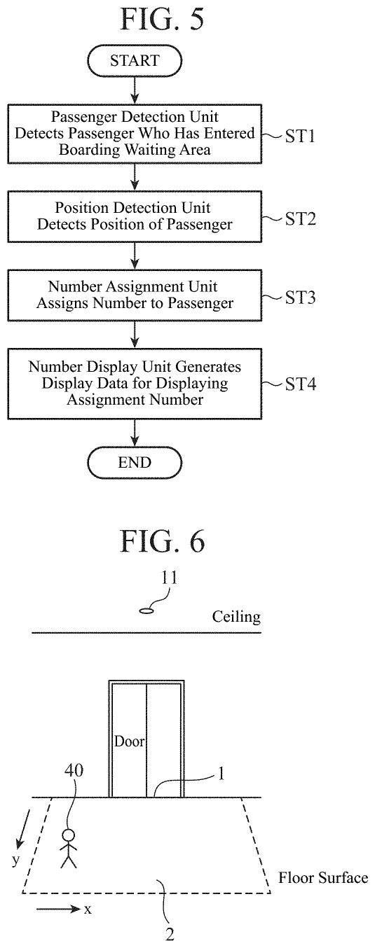

FIG. 5 is a flowchart illustrating a passenger guidance method which is a processing procedure performed in the signal processing unit 12.

Furthermore, FIG. 2 illustrates an example in which each of the components of the signal processing unit 12 is implemented by dedicated hardware, and FIG. 4 illustrates an example in which the signal processing unit 12 is implemented by software, firmware, or the like. However, this is merely an example, and some components in the signal processing unit 12 may be implemented by dedicated hardware, and the remaining components may be implemented by software, firmware, or the like.

Next, the operation of the passenger guidance device shown in FIG. 1 will be described.

In the passenger guidance device illustrated in FIG. 1, in order to simplify the description, description is given assuming that only a passenger 40 whose destination floor is an upper floor enters the boarding waiting area 2, or only a passenger 40 whose destination floor is a lower floor enters the boarding waiting area 2.

The monitoring camera 11 captures an image of an area including the boarding waiting area 2, and outputs image data of the area including the boarding waiting area 2 to each of the passenger detection unit 13 and the position detection unit 14.

Upon receiving the image data from the monitoring camera 11, the passenger detection unit 13 analyzes the image data to detect the passenger 40 who has entered the boarding waiting area 2 as illustrated in FIG. 6 (step ST1 in FIG. 5).

The process of analyzing the image data to detect the passenger 40 itself is a known technique, and thus a detailed description thereof will be omitted.

FIG. 6 is an explanatory diagram illustrating a passenger 40 who has entered the boarding waiting area 2.

FIG. 6 illustrates an example in which one passenger 40 has entered the boarding waiting area 2. However, this is merely an example, and two or more passengers 40 may enter the boarding waiting area 2.

When the passenger detection unit 13 detects a passenger 40 who has entered the boarding waiting area 2, if the detected passenger 40 is a passenger 40 whose ID is not registered in the passenger registration unit 17, the passenger detection unit 13 sets the ID of the detected passenger 40.

The passenger detection unit 13 counts the number of passengers 40 who have entered the boarding waiting area 2, and when the counted number is larger than the number of passengers 40 whose IDs are registered in the passenger registration unit 17, it is possible to determine that there is a passenger 40 whose ID is not registered in the passenger registration unit 17.

For the setting of the ID, for example, a random number output from a random number generator that generates a random number of several digits can be used. Here, in order to set a unique ID, the passenger detection unit 13 uses a random number generator. However, the passenger detection unit 13 only needs to be able to set a unique ID, and is not limited to one using a random number generator.

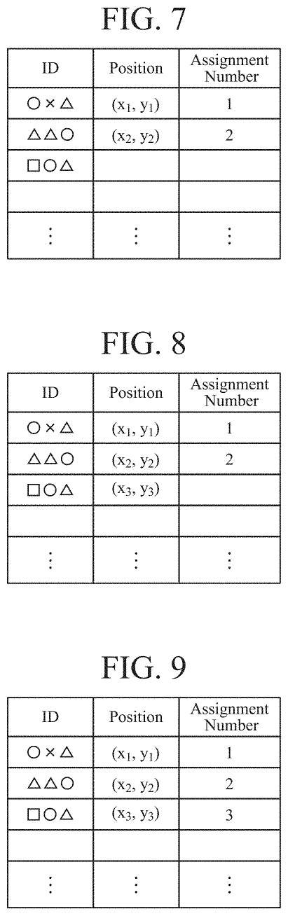

As illustrated in FIG. 7, the passenger detection unit 13 registers the ID of the detected passenger 40 in the passenger registration unit 17.

FIG. 7 is an explanatory diagram illustrating registered contents of the passenger registration unit 17.

FIG. 7 illustrates an example in which one passenger 40 has newly entered the boarding waiting area 2, and two passengers 40 have already entered the boarding waiting area 2 before the new passenger 40 enters the boarding waiting area 2.

In the example of FIG. 7, the passenger detection unit 13 registers “□◯Δ” in the passenger registration unit 17 as the ID of the passenger 40 who has newly entered the boarding waiting area 2.

For two passengers 40 who have already entered the boarding waiting area 2, positions and assignment numbers are registered in the passenger registration unit 17 in addition to IDs.

The passenger detection unit 13 outputs a detection signal K_{ID} indicating that the passenger 40 is detected to each of the position detection unit 14 and the number assignment unit 15. The detection signal K_{ID} includes the ID of the detected passenger 40.

Upon receiving the detection signal K_{ID} from the passenger detection unit 13, the position detection unit 14 analyzes the image data output from the monitoring camera 11 to detect the position of the passenger 40 who has newly entered the boarding waiting area 2 (step ST2 in FIG. 5).

The position of the passenger 40 is represented by, for example, (x, y) coordinates on a floor surface in the boarding waiting area 2.

When the position detection unit 14 detects positions (x₁, y₁), (x₂, y₂), and (x₃, y₃) of a plurality of passengers 40, IDs “◯×Δ” and “ΔΔ◯” different from the ID “□◯Δ” included in the detection signal K_{ID} may be registered in the passenger registration unit 17. Among the positions (x₁, y₁), (x₂, y₂), and (x₃, y₃) of the plurality of passengers 40, the position detection unit 14 determines that the position (x₃, y₃) different from each of the position (x₁, y₁) associated with the ID “◯×Δ” and the position (x₂, y₂) associated with the ID “ΔΔ◯” is the position of the passenger 40 having newly entered.

The process of analyzing the image data to detect the position of the passenger 40 itself is a known technique, and thus a detailed description thereof will be omitted.

As illustrated in FIG. 8, the position detection unit 14 registers the position (x₃, y₃) of the passenger 40 who has newly entered the boarding waiting area 2 in the passenger registration unit 17 so as to correspond to the ID “□◯Δ” included in the detection signal K_{ID}.

FIG. 8 is an explanatory diagram illustrating registered contents of the passenger registration unit 17.

Every time the latest image data is output from the monitoring camera 11, the position detection unit 14 analyzes the image data and performs tracking processing for all passengers 40 whose IDs are registered in the passenger registration unit 17, thereby detecting the positions of all passengers 40 after the movement. Since the tracking processing of the passenger 40 itself is a known technique, detailed description thereof will be omitted.

Further, the position detection unit 14 updates the positions of all passengers 40 associated with the IDs registered in the passenger registration unit 17 to the positions after the movement.

If the position of each passenger 40 after the movement is a position outside the boarding waiting area 2, the position detection unit 14 ends the tracking processing of the passenger 40.

The position detection unit 14 ends the tracking processing of each passenger 40 also when the passenger 40 boards the elevator and is not present in the boarding waiting area 2.

The position detection unit 14 deletes, from the passenger registration unit 17, the ID, the position, and the assignment number of the passenger 40 whose tracking processing has been ended.

The position detection unit 14 outputs a deletion signal including the ID of the passenger 40 whose tracking processing has been ended to the number assignment unit 15.

When the position detection unit 14 deletes the ID, the position, and the assignment number of the passenger 40 whose tracking processing has been ended, the assignment numbers associated with the respective IDs registered in the passenger registration unit 17 may become discontinuous numbers.

Upon receiving the deletion signal from the position detection unit 14, the number assignment unit 15 updates the assignment numbers associated with the respective IDs so that the assignment numbers associated with the respective IDs registered in the passenger registration unit 17 become continuous serial numbers.

Upon receiving the detection signal K_{ID} from the passenger detection unit 13, the number assignment unit 15 specifies the largest assignment number “2” among the assignment numbers associated with the respective IDs registered in the passenger registration unit 17.

The number assignment unit 15 assigns a number “3” larger by one than the specified assignment number “2” to the passenger 40 having the ID “□◯Δ” included in the detection signal K_{ID} output from the passenger detection unit 13 (step ST3 in FIG. 5).

As illustrated in FIG. 9, the number assignment unit 15 registers the number “3” assigned to the passenger 40 in the passenger registration unit 17 so as to correspond to the ID “□◯Δ” included in the detection signal K_{ID} output from the passenger detection unit 13.

FIG. 9 is an explanatory diagram illustrating registered contents of the passenger registration unit 17.

When the number assignment unit 15 registers the assignment number corresponding to the ID included in the detection signal K_{ID} in the passenger registration unit 17 or updates the assignment numbers associated with the respective IDs, the number assignment unit 15 outputs a display command of the assignment number to the number display unit 16.

Further, the number assignment unit 15 outputs a display command of the assignment number to the number display unit 16 every time a certain time elapses so that the position of the passenger 40 after the movement in the boarding waiting area 2 can be known.

Upon receiving the display command of the assignment number from the number assignment unit 15, the number display unit 16 acquires the assignment numbers associated with the respective IDs registered in the passenger registration unit 17 and the positions associated with the respective IDs.

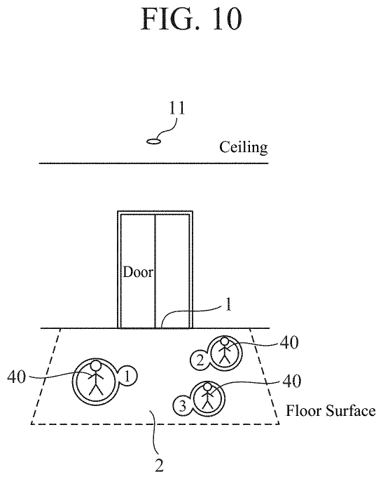

As illustrated in FIG. 10, the number display unit 16 generates display data for displaying the assignment numbers associated with the respective IDs on the floor surface around the positions associated with the respective IDs (step ST4 in FIG. 5).

FIG. 10 is an explanatory diagram illustrating numbers displayed on the floor surface around the positions of the passengers 40.

The number display unit 16 outputs the generated display data to a display apparatus 18.

Upon receiving the display data from the number display unit 16, the display apparatus 18 displays the numbers assigned by the number assignment unit 15 on the floor surface around the positions detected by the position detection unit 14 in accordance with the display data.

In the example of FIG. 10, since three passengers 40 are present in the boarding waiting area 2, the display apparatus 18 displays “1”, “2”, or “3” as the number indicating the boarding order to the elevator on the floor surface around the positions of the three passengers 40.

In the first embodiment described above, the passenger guidance device is configured in such a manner that it includes the number assignment unit 15 for assigning the number indicating the boarding order to the elevator to the passenger 40 detected by the passenger detection unit 13 every time the passenger detection unit 13 detects the passenger 40, and the number display unit 16 displays the number assigned by the number assignment unit 15 on the floor surface around the position detected by the position detection unit 14. Therefore, the passenger guidance device can allow the passenger 40 waiting for the arrival of the elevator to recognize the boarding order to the elevator.

### Second Embodiment

In the passenger guidance device illustrated in FIG. 1, the number display unit 16 displays the number assigned by the number assignment unit 15 on the floor surface around the position detected by the position detection unit 14.

In the second embodiment, a passenger guidance device will be described in which a number display unit 16 displays, in addition to the number assigned by the number assignment unit 15, guidance information prompting movement of the passenger 40 from the position detected by the position detection unit 14 to the entrance door 1 of the elevator on the floor surface in animation.

A configuration diagram illustrating a passenger guidance device of the second embodiment is illustrated in FIG. 1 similarly to the passenger guidance device of the first embodiment.

Next, the operation of the passenger guidance device will be described. The operation of the number display unit 16 will be mainly described here since the operation of the passenger guidance device other than the number display unit 16 is similar to that of the first embodiment.

Upon receiving the display command of the assignment number from the number assignment unit 15, the number display unit 16 acquires the assignment numbers associated with the respective IDs registered in the passenger registration unit 17 and the positions associated with the respective IDs as in the first embodiment.

As illustrated in FIG. 10, the number display unit 16 generates display data for displaying the assignment numbers associated with the respective IDs on the floor surface around the positions associated with the respective IDs.

The number display unit 16 outputs the generated display data to the display apparatus 18.

Upon receiving the display data from the number display unit 16, the display apparatus 18 displays the numbers assigned to the passengers 40 by the number assignment unit 15 on the floor surface around the positions detected by the position detection unit 14 in accordance with the display data as in the first embodiment.

In a case where it is predicted that the elevator will arrive soon, a control device (not illustrated) of the elevator outputs a generation command of guidance information to the number display unit 16 of the passenger guidance device.

As a situation in which the elevator is predicted to arrive soon, for example, a situation in which the descending elevator has passed through the floor one floor above or a situation in which the ascending elevator has passed through the floor one floor below can be considered.

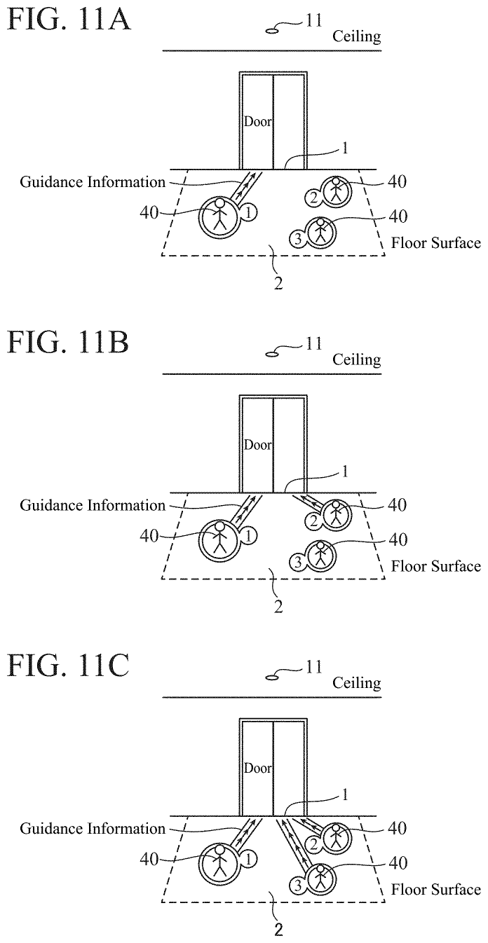

Upon receiving the generation command of the guidance information from the control device (not illustrated), the number display unit 16 generates display data for displaying the guidance information prompting the movement of the passengers 40 from the positions associated with the respective IDs to the entrance door 1 on the floor surface in animation as illustrated in FIG. 11.

FIG. 11A is an explanatory diagram illustrating an example of guidance information prompting movement of a passenger 40 from a position of a passenger 40 having an ID of assignment number=1 to the entrance door 1, and FIG. 11B is an explanatory diagram illustrating an example of guidance information prompting movement of a passenger 40 from a position of the passenger 40 having an ID of assignment number=2 to the entrance door 1.

FIG. 11C is an explanatory diagram illustrating an example of guidance information prompting movement of a passenger 40 from a position of the passenger 40 having an ID of assignment number=3 to the entrance door 1.

In the animation illustrated in FIGS. 11A to 11C, the position of the arrow flows from the position of the passenger 40 toward the entrance door 1 to prompt the movement of the passenger 40.

When a plurality of IDs are registered in the passenger registration unit 17, the number display unit 16 displays guidance information in turn from the guidance information for the passenger 40 having an ID with which a smaller assignment number is associated among the plurality of IDs.

In the example of FIG. 11, since three passengers 40 are present in the boarding waiting area 2, the number display unit 16 first displays the guidance information for the passenger 40 having the ID of the assignment number=1 (see FIG. 11A).

Next, the number display unit 16 displays the guidance information for the passenger 40 having the ID of the assignment number=2 (see FIG. 11B), and finally displays the guidance information for the passenger 40 having the ID of the assignment number=3 (see FIG. 11C).

In the second embodiment described above, the passenger guidance device is configured in such a manner that the number display unit 16 displays, in addition to the number assigned by the number assignment unit 15, guidance information prompting the movement of the passenger 40 from the position detected by the position detection unit 14 to the entrance door 1 of the elevator on the floor surface in animation. Therefore, the passenger guidance device can allow the passenger 40 waiting for the arrival of the elevator to recognize the boarding order to the elevator, and can also guide the passenger 40 waiting for the arrival of the elevator to the entrance door 1 of the elevator.

Further, in the second embodiment, the passenger guidance device is configured in such a manner that when a plurality of passengers are detected by the passenger detection unit 13, the number display unit 16 displays guidance information in turn from the guidance information for the passenger having a smaller number assigned by the number assignment unit 15 among the plurality of passengers. Therefore, the passenger guidance device can preferentially guide the passenger 40 whose boarding order is earlier to the entrance door 1 of the elevator.

### Third Embodiment

In the third embodiment, a passenger guidance device applicable to a plurality of elevators will be described.

In the third embodiment, it is assumed that two elevators are installed in order to simplify the description.

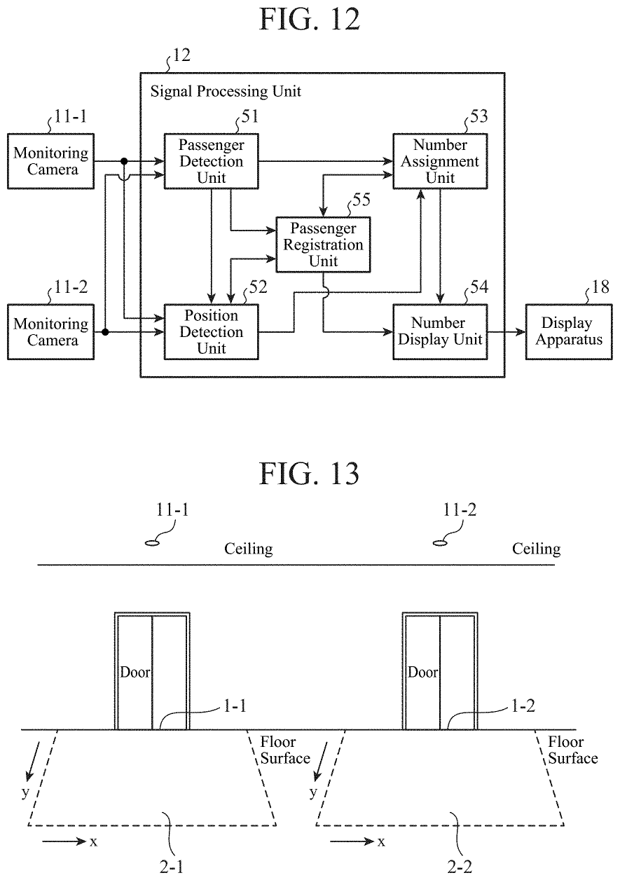

FIG. 12 is a configuration diagram illustrating the passenger guidance device according to the third embodiment. In FIG. 12, the same reference symbols as those in FIG. 1 denote the same or corresponding parts, and thus description thereof is omitted.

FIG. 13 is an explanatory diagram illustrating entrance doors 1-1 and 1-2 of two elevators and boarding waiting areas 2-1 and 2-2 of two elevators.

In FIG. 13, the entrance doors 1-1 and 1-2 are entrances of the respective elevators, and the positions of the entrance doors 1-1 and 1-2 are positions where doors of the respective elevators are installed.

The boarding waiting area 2-1 is an area in front of the entrance door 1-1, and is a space where a plurality of passengers 40 can wait.

The boarding waiting area 2-2 is an area in front of the entrance door 1-2, and is a space where a plurality of passengers 40 can wait.

Monitoring cameras 11-1 and 11-2 are installed on the ceiling.

The monitoring camera 11-1 captures an image of an area including the boarding waiting area 2-1, and outputs image data of the area including the boarding waiting area 2-1 to a signal processing unit 12.

The monitoring camera 11-2 captures an image of an area including the boarding waiting area 2-2, and outputs image data of the area including the boarding waiting area 2-2 to the signal processing unit 12.

In the passenger guidance device illustrated in FIG. 12, the monitoring cameras 11-1 and 11-2 are installed on the ceiling. However, this is merely an example, and the monitoring cameras 11-1 and 11-2 may be installed on a wall, for example.

The signal processing unit 12 includes a passenger detection unit 51, a position detection unit 52, a number assignment unit 53, a number display unit 54, and a passenger registration unit 55.

The passenger detection unit 51 is implemented by, for example, the passenger detection circuit 21 illustrated in FIG. 2.

The passenger detection unit 51 analyzes image data output from the monitoring camera 11-1 to detect a passenger 40 who has entered the boarding waiting area 2-1, and analyzes image data output from the monitoring camera 11-2 to detect a passenger 40 who has entered the boarding waiting area 2-2.

The passenger detection unit 51 outputs a detection signal K_{ID, AREA} indicating that the passenger 40 is detected to each of the position detection unit 52 and the number assignment unit 53. The detection signal K_{ID, AREA} includes an ID of the detected passenger 40. In addition, the detection signal K_{ID, AREA} includes area information AREA indicating whether the boarding waiting area which the passenger 40 has entered is the boarding waiting area 2-1 or the boarding waiting area 2-2.

Further, the passenger detection unit 51 registers the ID of the detected passenger 40 in the passenger registration unit 55.

In the passenger guidance device illustrated in FIG. 1, the passenger detection unit 51 analyzes the image data output from the monitoring camera 11-1, 11-2 to detect the passenger 40 who has entered the boarding waiting area 2-1, 2-2. However, this is merely an example, and when the passenger detection unit 51 is implemented by, for example, an object detection sensor or a human sensor, the passenger detection unit 51 can detect the passenger 40 who has entered the boarding waiting area 2-1, 2-2 using an ultrasonic wave or the like emitted by the passenger detection unit 51.

The position detection unit 52 is implemented by, for example, the position detection circuit 22 illustrated in FIG. 2.

The position detection unit 52 analyzes each of the image data output from the monitoring camera 11-1 and the image data output from the monitoring camera 11-2 to detect the position of the passenger 40 detected by the passenger detection unit 51.

The position detection unit 52 registers the position of the passenger 40 who has entered the boarding waiting area 2-1 in the passenger registration unit 55 so as to correspond to the ID included in the detection signal K_{ID, AREA} output from the passenger detection unit 13.

Further, the position detection unit 52 registers the position of the passenger 40 who has entered the boarding waiting area 2-2 in the passenger registration unit 55 so as to correspond to the ID included in the detection signal K_{ID, AREA} output from the passenger detection unit 13.

Every time image data is output from each of the monitoring camera 11-1 and the monitoring camera 11-2, the position detection unit 52 analyzes the image data, and performs tracking processing of all passengers 40 whose IDs are registered in the passenger registration unit 55, thereby detecting positions of all passengers 40 after the movement.

The position detection unit 52 updates the positions of all passengers 40 associated with the IDs registered in the passenger registration unit 55 to the positions after the movement.

The number assignment unit 53 is implemented by, for example, the number assignment circuit 23 illustrated in FIG. 2.

Every time the passenger detection unit 51 detects a passenger 40, the number assignment unit 53 acquires the area information AREA included in the detection signal K_{ID, AREA} output from the passenger detection unit 51.

The number assignment unit 53 assigns a number indicating a boarding order to the elevator corresponding to the boarding waiting area indicated by the area information AREA of the boarding waiting area 2-1 and the boarding waiting area 2-2 to the passenger 40 detected by the passenger detection unit 51.

The number assignment unit 53 registers an assignment number, which is the number assigned to the passenger 40 detected by the passenger detection unit 51, in the passenger registration unit 55 so as to correspond to the ID included in the detection signal K_{ID, AREA} output from the passenger detection unit 51.

The number display unit 54 is implemented by, for example, a number display circuit 24 illustrated in FIG. 2.

The number display unit 54 acquires an assignment number associated with the ID registered in the passenger registration unit 55 and a position associated with the ID registered in the passenger registration unit 55.

The number display unit 54 generates display data for displaying the assignment number associated with the ID on the floor surface around the position associated with the ID.

The number display unit 54 outputs the generated display data to the display apparatus 18.

The passenger registration unit 55 is implemented by, for example, the passenger registration circuit 25 illustrated in FIG. 2.

The passenger registration unit 55 registers the ID, the position, and the assignment number of the passenger 40 who has entered the boarding waiting area 2-1.

The passenger registration unit 55 registers the ID, the position, and the assignment number of the passenger 40 who has entered the boarding waiting area 2-2.

In FIG. 12, it is assumed that each of the passenger detection unit 51, the position detection unit 52, the number assignment unit 53, the number display unit 54, and the passenger registration unit 55, which are components of the signal processing unit 12, is implemented by dedicated hardware as illustrated in FIG. 2. That is, it is assumed that the signal processing unit 12 is implemented by the passenger detection circuit 21, the position detection circuit 22, the number assignment circuit 23, the number display circuit 24, and the passenger registration circuit 25.

The components of the signal processing unit 12 are not limited to those implemented by dedicated hardware, but the signal processing unit 12 may be implemented by software, firmware, or a combination of software and firmware.

In a case where the signal processing unit 12 is implemented by software, firmware, or the like, the passenger registration unit 55 is configured on the memory 31 of the computer illustrated in FIG. 4. A program for causing a computer to execute processing procedures performed in the passenger detection unit 51, the position detection unit 52, the number assignment unit 53, and the number display unit 54 is stored in the memory 31. Then, a processor 32 of the computer executes the program stored in the memory 31.

Next, the operation of the passenger guidance device shown in FIG. 12 will be described.

The monitoring camera 11-1 captures an image of an area including the boarding waiting area 2-1, and outputs image data of the area including the boarding waiting area 2-1 to each of the passenger detection unit 51 and the position detection unit 52.

The monitoring camera 11-2 captures an image of an area including the boarding waiting area 2-2, and outputs image data of the area including the boarding waiting area 2-2 to each of the passenger detection unit 51 and the position detection unit 52.

Upon receiving the image data from the monitoring camera 11-1, the passenger detection unit 51 analyzes the image data to detect the passenger 40 who has entered the boarding waiting area 2-1, similarly to the passenger detection unit 13 illustrated in FIG. 1.

Upon receiving the image data from the monitoring camera 11-2, the passenger detection unit 51 analyzes the image data to detect the passenger 40 who has entered the boarding waiting area 2-2, similarly to the passenger detection unit 13 illustrated in FIG. 1.

When the passenger detection unit 51 detects the passenger 40 who has entered the boarding waiting area 2-1, similarly to the passenger detection unit 13 illustrated in FIG. 1, if the detected passenger 40 is the passenger 40 whose ID is not registered in the passenger registration unit 55, the passenger detection unit 51 sets the ID of the detected passenger 40.

When the passenger detection unit 51 detects the passenger 40 who has entered the boarding waiting area 2-2, similarly to the passenger detection unit 13 illustrated in FIG. 1, if the detected passenger 40 is a passenger 40 whose ID is not registered in the passenger registration unit 55, the passenger detection unit 51 sets the ID of the detected passenger 40.

The passenger detection unit 51 registers the ID, the position, and the assignment number of the passenger 40 in the passenger registration unit 55 for each boarding waiting area.

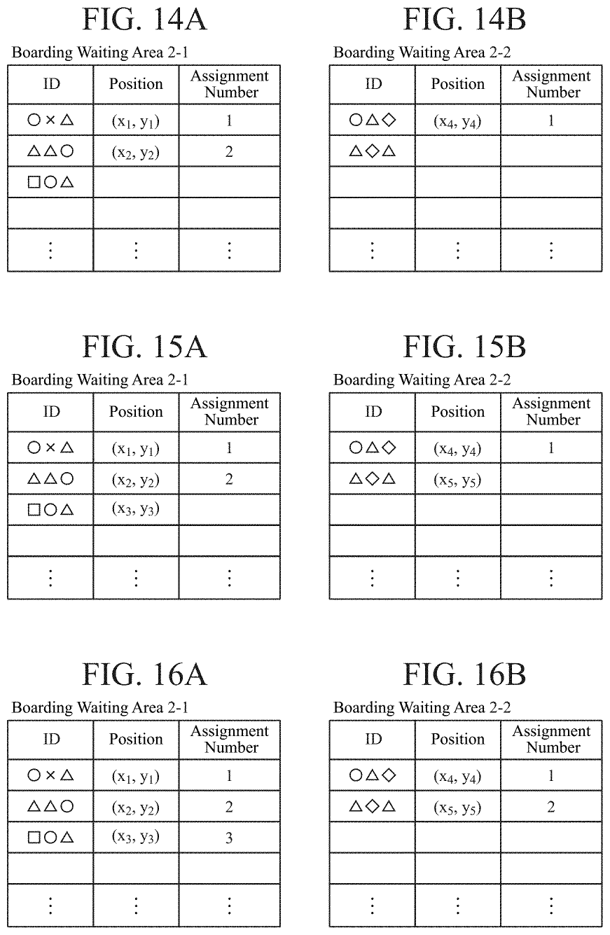

Specifically, as illustrated in FIG. 14A, the passenger detection unit 51 registers the ID of the passenger 40 who has entered the boarding waiting area 2-1 in the passenger registration unit 55.

As illustrated in FIG. 14B, the passenger detection unit 51 registers the ID of the passenger 40 who has entered the boarding waiting area 2-2 in the passenger registration unit 55.

FIG. 14A is an explanatory diagram illustrating registered contents of the passenger registration unit 55 related to the passenger 40 who has entered the boarding waiting area 2-1.

FIG. 14B is an explanatory diagram illustrating registered contents of the passenger registration unit 55 related to the passenger 40 who has entered the boarding waiting area 2-2.

FIG. 14A illustrates an example in which one passenger 40 has newly entered the boarding waiting area 2-1, and two passengers 40 have already entered the boarding waiting area 2-1 before the new passenger 40 enters the boarding waiting area 2.

In the example of FIG. 14A, the passenger detection unit 51 registers “□◯Δ” in the passenger registration unit 55 as the ID of passenger 40 who has newly entered the boarding waiting area 2-1.

For two passengers 40 who have already entered the boarding waiting area 2-1, the positions and assignment numbers are registered in the passenger registration unit 55 in addition to the IDs.

FIG. 14B illustrates an example in which one passenger 40 has newly entered the boarding waiting area 2-2, and one passenger 40 has already entered the boarding waiting area 2-2 before the new passenger 40 enters the boarding waiting area 2.

In the example of FIG. 14B, the passenger detection unit 51 registers “Δ [symbol] Δ” in the passenger registration unit 55 as the ID of the passenger 40 who has newly entered the boarding waiting area 2-2.

For one passenger 40 who has already entered the boarding waiting area 2-2, the position and assignment number are registered in the passenger registration unit 55 in addition to the ID.

The passenger detection unit 51 outputs a detection signal K_{ID, AREA} indicating that the passenger 40 is detected to each of the position detection unit 52 and the number assignment unit 53.

Upon receiving the detection signal K_{ID, AREA} from the passenger detection unit 51, similarly to the position detection unit 14 illustrated in FIG. 1, the position detection unit 52 analyzes the image data output from the monitoring camera 11-1 to detect the position (x₃, y₃) of the passenger 40 who has newly entered the boarding waiting area 2-1.

Similarly to the position detection unit 14 illustrated in FIG. 1, the position detection unit 52 analyzes the image data output from the monitoring camera 11-2 to detect the position (x₅, y₅) of the passenger 40 who has newly entered the boarding waiting area 2-2.

As illustrated in FIG. 15A, the position detection unit 52 registers the position (x₃, y₃) of the passenger 40 who has newly entered the boarding waiting area 2-1 in the passenger registration unit 55 so as to correspond to the ID “□◯Δ” included in the detection signal K_{ID, AREA} output from the passenger detection unit 51.

As illustrated in FIG. 15B, the position detection unit 52 registers the position (x₅, y₅) of the passenger 40 who has newly entered the boarding waiting area 2-2 in the passenger registration unit 55 so as to correspond to the ID “Δ [symbol] Δ” included in the detection signal K_{ID, AREA} output from the passenger detection unit 51.

FIG. 15A is an explanatory diagram illustrating registered contents of the passenger registration unit 55 related to the passenger 40 who has entered the boarding waiting area 2-1.

FIG. 15B is an explanatory diagram illustrating registered contents of the passenger registration unit 55 related to the passenger 40 who has entered the boarding waiting area 2-2.

Every time the latest image data is output from each of the monitoring camera 11-1 and the monitoring camera 11-2, the position detection unit 52 analyzes each image data and performs tracking processing of all passengers 40 whose IDs are registered in the passenger registration unit 55, thereby detecting the positions of all passengers 40 after the movement.

Further, similarly to the position detection unit 14 illustrated in FIG. 1, the position detection unit 52 updates the positions of all passengers 40 associated with the IDs registered in the passenger registration unit 55 to the positions after the movement.

When the passenger 40 who has entered the boarding waiting area 2-1 moves and goes out of the boarding waiting area 2-1, the position detection unit 52 ends the tracking processing of the passenger 40 who has entered the boarding waiting area 2-1.

The position detection unit 52 ends the tracking processing of the passenger 40 also when the passenger 40 who has entered the boarding waiting area 2-1 boards the elevator and is not present in the boarding waiting area 2-1.

When the passenger 40 who has entered the boarding waiting area 2-2 moves and goes out of the boarding waiting area 2-2, the position detection unit 52 ends the tracking processing of the passenger 40 who has entered the boarding waiting area 2-2.

The position detection unit 52 ends the tracking processing of the passenger 40 also when the passenger 40 who has entered the boarding waiting area 2-2 boards the elevator and is not present in the boarding waiting area 2-2.

The position detection unit 52 deletes, from the passenger registration unit 55, the ID, the position, and the assignment number of the passenger 40 whose tracking processing has been ended.

The position detection unit 52 outputs a deletion signal including the ID of the passenger 40 whose tracking processing has been ended to the number assignment unit 53.

When the position detection unit 52 deletes the ID, the position, and the assignment number of the passenger 40 whose tracking processing has been ended, the assignment numbers associated with the respective IDs registered in the passenger registration unit 55 may become discontinuous numbers.

Upon receiving the deletion signal from the position detection unit 52, the number assignment unit 53 updates the assignment numbers associated with the respective IDs so that the assignment numbers associated with the respective IDs registered in the passenger registration unit 55 become continuous serial numbers.

Upon receiving the detection signal K_{ID, AREA} from the passenger detection unit 51, the number assignment unit 53 determines whether the boarding waiting area indicated by the area information AREA included in the detection signal K_{ID, AREA} is the boarding waiting area 2-1 or the boarding waiting area 2-2.

If the boarding waiting area indicated by the area information AREA is the boarding waiting area 2-1, the number assignment unit 53 specifies the largest assignment number “2” among the assignment numbers associated with the IDs of the passengers 40 entering the boarding waiting area 2-1.

The number assignment unit 53 assigns a number “3” larger by one than the specified assignment number “2” to the passenger 40 having the ID “□◯Δ” included in the detection signal K_{ID, AREA} output from the passenger detection unit 51.

As illustrated in FIG. 16A, the number assignment unit 53 registers the number “3” assigned to the passenger 40 in the passenger registration unit 55 so as to correspond to the ID “□◯Δ” included in the detection signal K_{ID, AREA} output from the passenger detection unit 51.

If the boarding waiting area indicated by the area information AREA is the boarding waiting area 2-2, the number assignment unit 53 specifies the largest assignment number “1” among the assignment numbers associated with the IDs of the passengers 40 entering the boarding waiting area 2-2.

The number assignment unit 53 assigns a number “2” larger by one than the specified assignment number “1” to the passenger 40 having the ID “Δ [symbol] Δ” included in the detection signal K_{ID, AREA} output from the passenger detection unit 51.

As illustrated in FIG. 16B, the number assignment unit 53 registers the number “2” assigned to the passenger 40 in the passenger registration unit 55 so as to correspond to the ID “Δ [symbol] Δ” included in the detection signal K_{ID, AREA} output from the passenger detection unit 51.

FIG. 16A is an explanatory diagram illustrating registered contents of the passenger registration unit 55 related to the passenger 40 who has entered the boarding waiting area 2-1.

FIG. 16B is an explanatory diagram illustrating registered contents of the passenger registration unit 55 related to the passenger 40 who has entered the boarding waiting area 2-2.

When the number assignment unit 53 registers the assignment number corresponding to the ID included in the detection signal K_{ID, AREA} in the passenger registration unit 55 or updates the assignment numbers associated with the respective IDs, the number assignment unit 53 outputs a display command of the assignment number to the number display unit 54.

Further, the number assignment unit 53 outputs a display command of the assignment number to the number display unit 54 every time a certain period of time elapses.

Upon receiving the display command of the assignment number from the number assignment unit 53, the number display unit 54 acquires the assignment numbers associated with the respective IDs registered in the passenger registration unit 55 and the positions associated with the respective IDs.

As illustrated in FIG. 17, the number display unit 54 generates display data for displaying the assignment numbers associated with the respective IDs on the floor surface around the positions associated with the respective IDs.

FIG. 17 is an explanatory diagram illustrating numbers displayed on the floor surface around the positions of passengers 40.

The number display unit 54 outputs the generated display data to the display apparatus 18.

Upon receiving the display data from the number display unit 54, the display apparatus 18 displays the number assigned by the number assignment unit 53 on the floor surface around the position detected by the position detection unit 52 in accordance with the display data.

In the example of FIG. 17, since three passengers 40 are present in the boarding waiting area 2-1, the display apparatus 18 displays “1”, “2”, or “3” as the number indicating the boarding order to the elevator on the floor surface around the positions of the three passengers 40.

Since two passengers 40 are present in the boarding waiting area 2-2, the display apparatus 18 displays “1” or “2” as the number indicating the boarding order to the elevator on the floor surface around the positions of the two passengers 40.

In the passenger guidance device illustrated in FIG. 12, even in a case where a plurality of elevators are installed, similarly to the passenger guidance device illustrated in FIG. 1, the passenger 40 waiting for the arrival of the elevator can recognize the boarding order to the elevator.

In the passenger guidance device illustrated in FIG. 12, similarly to the number display unit 16 illustrated in the second embodiment, the number display unit 54 may display, in addition to the number assigned by the number assignment unit 53, guidance information prompting movement of the passenger 40 from the position in the boarding waiting area 2-1 detected by the position detection unit 52 to the entrance door 1-1 of the elevator on the floor surface in animation.

In addition, the number display unit 54 may display guidance information prompting movement of the passenger 40 from the position in the boarding waiting area 2-2 detected by the position detection unit 52 to the entrance door 1-2 of the elevator on the floor surface in animation.

### Fourth Embodiment

In the fourth embodiment, a passenger guidance device including an elevator specifying unit 61 for specifying an elevator which a passenger detected by a passenger detection unit 51 is to board among a plurality of elevators on the basis of a registered destination floor when a destination floor of the passenger 40 detected by the passenger detection unit 51 is registered will be described.

In the fourth embodiment, it is assumed that two elevators are installed in order to simplify the description.

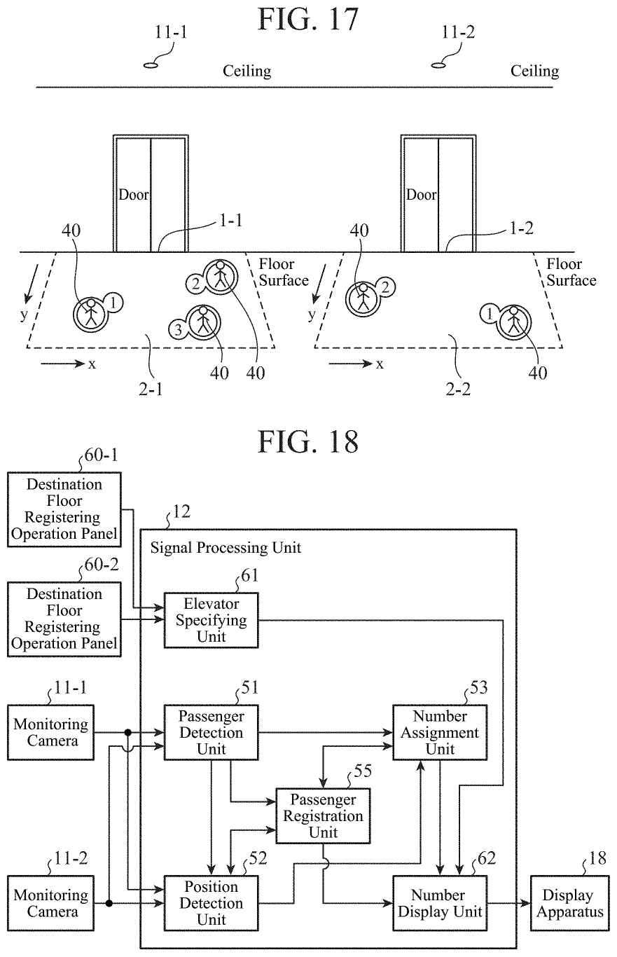

FIG. 18 is a configuration diagram illustrating the passenger guidance device according to the fourth embodiment. In FIG. 18, the same reference symbols as those in FIGS. 1 and 12 denote the same or corresponding parts, and thus description thereof is omitted.

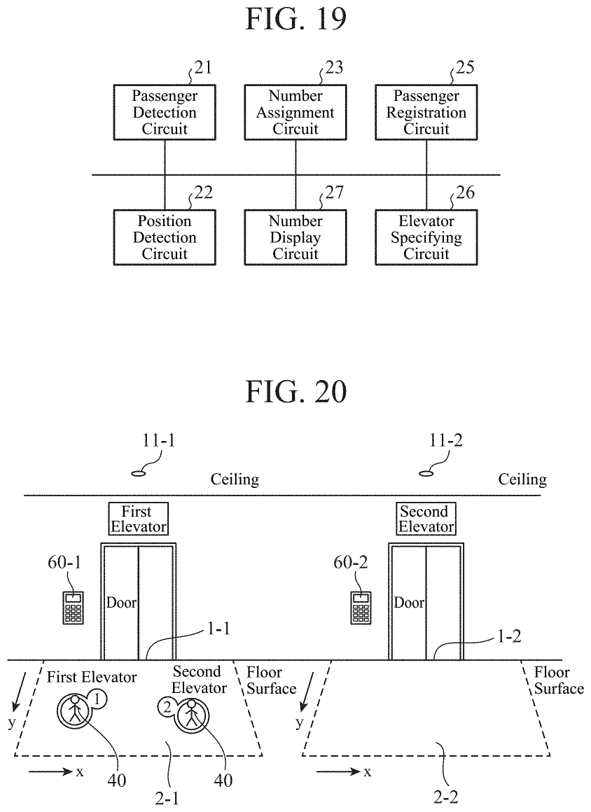

FIG. 19 is a hardware configuration diagram illustrating hardware of a signal processing unit 12 in the passenger guidance device according to the fourth embodiment. In FIG. 19, the same reference symbols as those in FIG. 2 denote the same or corresponding parts, and thus description thereof is omitted.

FIG. 20 is an explanatory diagram illustrating the entrance doors 1-1 and 1-2 of two elevators and the boarding waiting areas 2-1 and 2-2 of the two elevators. In FIG. 20, the same reference symbols as those in FIG. 13 denote the same or corresponding parts, and thus description thereof is omitted.

A destination floor registering operation panel 60-1 is installed near the entrance door 1-1 of the elevator, and a destination floor registering operation panel 60-2 is installed near the entrance door 1-2 of the elevator.

Each of the destination floor registering operation panel 60-1 and the destination floor registering operation panel 60-2 receives a registration operation of a destination floor by the passenger 40 detected by the passenger detection unit 51, and outputs registration information of the destination floor to the elevator specifying unit 61 of the signal processing unit 12.

In FIG. 20, the destination floor registering operation panel 60-1 is attached to a wall near the entrance door 1-1 of the elevator, and the destination floor registering operation panel 60-2 is attached to a wall near the entrance door 1-2 of the elevator. However, this is merely an example, and the destination floor registering operation panel 60-1 may be installed as a self-standing operation panel on a floor near the boarding waiting area 2-1, for example. Further, the destination floor registering operation panel 60-2 may be installed as a self-standing operation panel on a floor near the boarding waiting area 2-2, for example.

The elevator specifying unit 61 is implemented by, for example, an elevator specifying circuit 26 illustrated in FIG. 19.

The elevator specifying unit 61 specifies the elevator which the passenger 40 detected by the passenger detection unit 51 is to board among the two elevators on the basis of the destination floor indicated by the registration information of the destination floor output from either the destination floor registering operation panel 60-1 or the destination floor registering operation panel 60-2.

A number display unit 62 is implemented by, for example, a number display circuit 27 illustrated in FIG. 19.

Similarly to the number display unit 54 illustrated in FIG. 12, the number display unit 62 generates display data for displaying the assignment number associated with the ID on the floor surface around the position associated with the ID registered in the passenger registration unit 55.

In addition, the number display unit 62 generates display data for displaying an elevator number of the elevator specified by the elevator specifying unit 61 on the floor surface.

In FIG. 18, it is assumed that each of the passenger detection unit 51, the position detection unit 52, the number assignment unit 53, the elevator specifying unit 61, the number display unit 62, and the passenger registration unit 55, which are components of the signal processing unit 12, is implemented by dedicated hardware as illustrated in FIG. 19. That is, it is assumed that the signal processing unit 12 is implemented by the passenger detection circuit 21, the position detection circuit 22, the number assignment circuit 23, the elevator specifying circuit 26, the number display circuit 27, and the passenger registration circuit 25.

Here, each of the elevator specifying circuit 26 and the number display circuit 27 corresponds to, for example, a single circuit, a composite circuit, a programmed processor, a parallel programmed processor, ASIC, FPGA, or a combination thereof.

The components of the signal processing unit 12 are not limited to those implemented by dedicated hardware, but the signal processing unit 12 may be implemented by software, firmware, or a combination of software and firmware.

In a case where the signal processing unit 12 is implemented by software, firmware, or the like, the passenger registration unit 55 is configured on the memory 31 of the computer illustrated in FIG. 4. A program for causing a computer to execute processing procedures performed in the passenger detection unit 51, the position detection unit 52, the number assignment unit 53, the elevator specifying unit 61, and the number display unit 62 is stored in the memory 31. Then, a processor 32 of the computer executes the program stored in the memory 31.

Next, the operation of the passenger guidance device shown in FIG. 18 will be described.

Since the operation of the passenger guidance device other than the destination floor registering operation panel 60-1, 60-2, the elevator specifying unit 61, and the number display unit 62 is similar to that of the passenger guidance device illustrated in FIG. 12, the operation of the destination floor registering operation panel 60-1, 60-2, the elevator specifying unit 61, and the number display unit 62 will be mainly described here.

Further, for convenience of description, it is assumed that, among the two elevators illustrated in FIG. 20, the elevator on the left side in the drawing is a first elevator, and the elevator on the right side in the drawing is a second elevator.

In addition, it is assumed that stop floors of the first elevator are the first floor and the tenth floor to the fifteenth floor, and pass-through floors of the first elevator are the second floor to the ninth floor.

It is assumed that stop floors of the second elevator are the first floor to the tenth floor.

The passenger 40 detected by the passenger detection unit 51 can register the destination floor by operating either the destination floor registering operation panel 60-1 or the destination floor registering operation panel 60-2.

Each of the destination floor registering operation panel 60-1 and the destination floor registering operation panel 60-2 receives the registration operation of the destination floor by the passenger 40, and outputs the registration information of the destination floor to the elevator specifying unit 61.

Upon receiving the registration information of the destination floor from either the destination floor registering operation panel 60-1 or the destination floor registering operation panel 60-2, the elevator specifying unit 61 specifies that the elevator which the passenger 40 detected by the passenger detection unit 51 is to board is the second elevator when the destination floor indicated by the registration information is, for example, any one of the second to ninth floors.

If the destination floor indicated by the registration information is, for example, any one of the tenth to fifteenth floors, the elevator specifying unit 61 specifies that the elevator which the passenger 40 detected by the passenger detection unit 51 is to board is the first elevator.

The elevator specifying unit 61 outputs elevator specifying information indicating the specified elevator to the number display unit 62.

Similarly to the number display unit 54 illustrated in FIG. 12, the number display unit 62 generates display data for displaying the assignment number associated with the ID on the floor surface around the position associated with the ID registered in the passenger registration unit 55.

In addition, the number display unit 62 generates display data for displaying an elevator number of the elevator indicated by the elevator specifying information output from the elevator specifying unit 61 on the floor surface.

When the elevator which the passenger 40 is to board is the first elevator, the number display unit 62 generates display data for displaying “first elevator” on the floor surface.

If the elevator which the passenger 40 is to board is the second elevator, the number display unit 62 generates display data for displaying “second elevator” on the floor surface.

The number display unit 62 outputs the generated display data to the display apparatus 18.

Upon receiving the display data from the number display unit 62, the display apparatus 18 displays the number assigned by the number assignment unit 53 on the floor surface around the position detected by the position detection unit 52 in accordance with the display data.

In addition, as illustrated in FIG. 20, the display apparatus 18 displays the elevator number of the elevator which the passenger 40 is to board on the floor surface.

In the example of FIG. 20, two passengers 40 are present in the boarding waiting area 2-1, and no passenger 40 is present in the boarding waiting area 2-2.

In the example of FIG. 20, since the elevator which the passenger 40 present on the left side in the drawing among the two passengers 40 is to board is the first elevator, the display apparatus 18 displays “first elevator” on the floor surface around the passenger 40 present on the left side.

In the example of FIG. 20, since the elevator which the passenger 40 present on the right side in the drawing among the two passengers 40 is to board is the second elevator, the display apparatus 18 displays “second elevator” on the floor surface around the passenger 40 present on the right side.

In the fourth embodiment described above, the passenger guidance device is configured in such a manner that it includes the elevator specifying unit 61 for specifying, when the destination floor of the passenger 40 detected by the passenger detection unit 51 is registered, the elevator which the passenger 40 detected by the passenger detection unit 51 is to board among the plurality of elevators on the basis of the registered destination floor and the number display unit 62 displays, in addition to the number assigned by the number assignment unit 53, the elevator number of the elevator specified by the elevator specifying unit 61 on the floor surface. Therefore, similarly to the passenger guidance device illustrated in FIGS. 1 and 12, the passenger guidance device can allow the passenger 40 waiting for the arrival of the elevator to recognize the boarding order to the elevator, and can also allow the passenger 40 to be guided to the boarding waiting area of the elevator which the passenger 40 is to board.

In the passenger guidance device illustrated in FIG. 18, similarly to the number display unit 16 illustrated in the second embodiment, the number display unit 62 may display, in addition to the number assigned by the number assignment unit 53, guidance information prompting movement of the passenger 40 from the position in the boarding waiting area 2-1 detected by the position detection unit 52 to the entrance door 1-1 of the elevator on the floor surface in animation.

In addition, the number display unit 62 may display guidance information prompting movement of the passenger 40 from the position in the boarding waiting area 2-2 detected by the position detection unit 52 to the entrance door 1-2 of the elevator on the floor surface in animation.

In the fourth embodiment, it is assumed that the stop floors of the first elevator are the first floor and the tenth floor to the fifteenth floor, and the stop floors of the second elevator are the first floor to the tenth floor.

However, this is merely an example, and the stop floors of the first elevator and the second elevator may be, for example, the first floor to the tenth floor.

Here, for convenience of description, it is assumed that the stop floors of the first elevator and the second elevator are the first floor to the tenth floor. Further, it is assumed that each of the boarding waiting area 2-1 and the boarding waiting area 2-2 is provided on the fifth floor.

In this case, it is assumed that the first elevator is ascending near the third floor and the second elevator is descending near the eighth floor.

In this situation, there is a higher possibility that the first elevator reaches the fifth floor where the passenger 40 waits earlier than the second elevator. Therefore, the elevator specifying unit 61 may specify that the elevator which the passenger 40 is to board is the first elevator.

### Fifth Embodiment

In the fifth embodiment, a passenger guidance device including an area matching determining unit 63 for determining whether or not a boarding waiting area including the position of the passenger 40 detected by a position detection unit 52 matches a boarding waiting area of the elevator specified by an elevator specifying unit 61 will be described.

In the fifth embodiment, it is assumed that two elevators are installed in order to simplify the description.

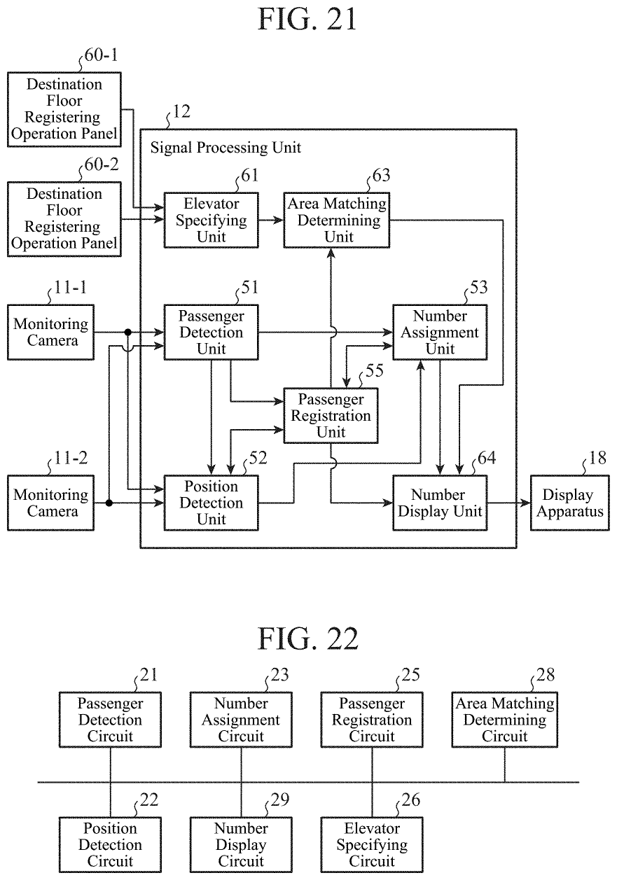

FIG. 21 is a configuration diagram illustrating a passenger guidance device according to the fifth embodiment. In FIG. 21, the same reference symbols as those in FIGS. 1, 12, and 18 denote the same or corresponding parts, and thus description thereof is omitted.

FIG. 22 is a hardware configuration diagram illustrating hardware of a signal processing unit 12 in the passenger guidance device according to the fifth embodiment. In FIG. 22, the same reference symbols as those in FIGS. 2 and 19 denote the same or corresponding parts, and thus description thereof is omitted.

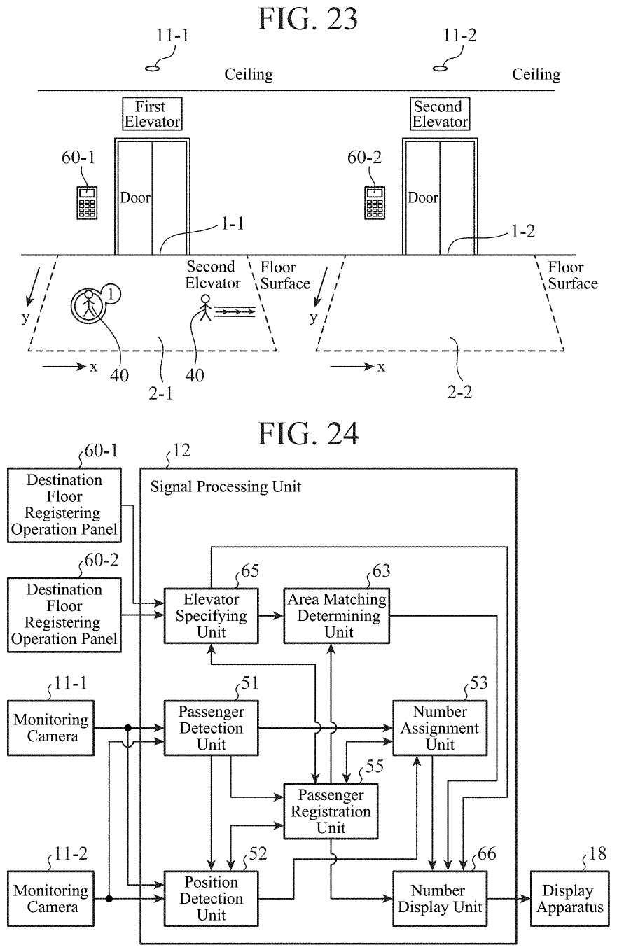

FIG. 23 is an explanatory diagram illustrating entrance doors 1-1 and 1-2 of two elevators and boarding waiting areas 2-1 and 2-2 of the two elevators. In FIG. 23, the same reference symbols as those in FIGS. 13 and 20 denote the same or corresponding parts, and thus description thereof is omitted.

The area matching determining unit 63 is implemented by, for example, an area matching determining circuit 28 illustrated in FIG. 22.

The area matching determining unit 63 acquires the position of the passenger 40 detected by the position detection unit 52 from the passenger registration unit 55, and determines whether the boarding waiting area including the position of the passenger 40 is the boarding waiting area 2-1 or the boarding waiting area 2-2.

The area matching determining unit 63 determines whether or not the boarding waiting area including the position of the passenger 40 matches the boarding waiting area of the elevator specified by the elevator specifying unit 61.

The number display unit 64 is implemented by, for example, a number display circuit 29 illustrated in FIG. 22.

When the area matching determining unit 63 determines that the areas match, the number display unit 64 generates display data for displaying the assignment number associated with the ID on the floor surface around the position associated with the ID registered in the passenger registration unit 55 similarly to the number display unit 54 illustrated in FIG. 12.

Further, when the area matching determining unit 63 determines that the areas do not match, the number display unit 64 generates display data for displaying the elevator number of the elevator specified by the elevator specifying unit 61 on the floor surface.

In FIG. 21, it is assumed that each of the passenger detection unit 51, the position detection unit 52, the number assignment unit 53, the elevator specifying unit 61, the area matching determining unit 63, the number display unit 64, and the passenger registration unit 55, which are components of the signal processing unit 12, is implemented by dedicated hardware as illustrated in FIG. 22. That is, it is assumed that the signal processing unit 12 is implemented by the passenger detection circuit 21, the position detection circuit 22, the number assignment circuit 23, the elevator specifying circuit 26, the area matching determining circuit 28, the number display circuit 29, and the passenger registration circuit 25.

Here, each of the area matching determining circuit 28 and the number display circuit 29 corresponds to, for example, a single circuit, a composite circuit, a programmed processor, a parallel-programmed processor, ASIC, FPGA, or a combination thereof.

The components of the signal processing unit 12 are not limited to those implemented by dedicated hardware, but the signal processing unit 12 may be implemented by software, firmware, or a combination of software and firmware.

In a case where the signal processing unit 12 is implemented by software, firmware, or the like, the passenger registration unit 55 is configured on the memory 31 of the computer illustrated in FIG. 4. A program for causing a computer to execute processing procedures of the passenger detection unit 51, the position detection unit 52, the number assignment unit 53, the elevator specifying unit 61, the area matching determining unit 63, and the number display unit 64 is stored in the memory 31. Then, a processor 32 of the computer executes the program stored in the memory 31.

Next, the operation of the passenger guidance device shown in FIG. 21 will be described.

Since the operation of the passenger guidance device other than the area matching determining unit 63 and the number display unit 64 is similar to that of the passenger guidance device illustrated in FIGS. 12 and 18, the operation of the area matching determining unit 63 and the number display unit 64 will be mainly described here.

In addition, for convenience of description, it is assumed that, among the two elevators illustrated in FIG. 23, the elevator on the left side in the drawing is a first elevator, and the elevator on the right side in the drawing is a second elevator.

The area matching determining unit 63 acquires the position of the passenger 40 detected by the position detection unit 52 from the passenger registration unit 55.

If the acquired position is a coordinate in the boarding waiting area 2-1, the area matching determining unit 63 determines that the boarding waiting area including the position of the passenger 40 is the boarding waiting area 2-1.

If the acquired position is a coordinate in the boarding waiting area 2-2, the area matching determining unit 63 determines that the boarding waiting area including the position of the passenger 40 is the boarding waiting area 2-2.

The area matching determining unit 63 determines whether or not the boarding waiting area including the position of the passenger 40 matches the boarding waiting area of the elevator specified by the elevator specifying unit 61.

When the boarding waiting area including the position of the passenger 40 is the boarding waiting area 2-1, if the boarding waiting area of the elevator specified by the elevator specifying unit 61 is the boarding waiting area 2-1, the area matching determining unit 63 determines that the areas match.

Further, when the boarding waiting area including the position of the passenger 40 is the boarding waiting area 2-2, if the boarding waiting area of the elevator specified by the elevator specifying unit 61 is the boarding waiting area 2-2, the area matching determining unit 63 determines that the areas match.

When the boarding waiting area including the position of the passenger 40 is the boarding waiting area 2-1, if the boarding waiting area of the elevator specified by the elevator specifying unit 61 is the boarding waiting area 2-2, the area matching determining unit 63 determines that the areas do not match.

Further, when the boarding waiting area including the position of the passenger 40 is the boarding waiting area 2-2, if the boarding waiting area of the elevator specified by the elevator specifying unit 61 is the boarding waiting area 2-1, the area matching determining unit 63 determines that the areas do not match.

The area matching determining unit 63 outputs a determination result indicating whether or not the areas match to the number display unit 64.

When the determination result output from the area matching determining unit 63 indicates matching, the number display unit 64 generates display data for displaying the assignment number associated with the ID on the floor surface around the position associated with the ID registered in the passenger registration unit 55, similarly to the number display unit 54 illustrated in FIG. 12.

When the determination result output from the area matching determining unit 63 indicates that the areas do not match, the number display unit 64 generates display data for displaying the elevator number of the elevator specified by the elevator specifying unit 61 on the floor surface.

The number display unit 64 outputs the generated display data to the display apparatus 18.

Upon receiving the display data from the number display unit 64, the display apparatus 18 displays the number assigned by the number assignment unit 53 or the elevator number of the elevator specified by the elevator specifying unit 61 on the floor surface around the position detected by the position detection unit 52 in accordance with the display data.

In the example of FIG. 23, two passengers 40 are present in the boarding waiting area 2-1, and no passenger 40 is present in the boarding waiting area 2-2.

In the example of FIG. 23, since the elevator which the passenger 40 present on the left side in the drawing among the two passengers 40 is to board is the first elevator, the display apparatus 18 displays the assignment number “1” on the floor surface around the passenger 40 present on the left side.

In the example of FIG. 23, since the elevator which the passenger 40 present on the right side in the drawing among the two passengers 40 is to board is the second elevator, the display apparatus 18 displays “second elevator” on the floor surface around the passenger 40 present on the right side. In addition, the display apparatus 18 displays a guidance animation on the floor surface around the passenger 40 present on the right side. In the guidance animation shown in FIG. 23, the position of the arrow flows from the position of the passenger 40 in the direction of the boarding waiting area 2-2 to prompt the movement of the passenger 40.

Note that the display apparatus 18 may blink the elevator number or change the display color of the elevator number in order to emphasize the guidance.

In the fifth embodiment described above, the passenger guidance device is configured in such a manner that it includes the area matching determining unit 63 for determining whether or not the boarding waiting area including the position detected by the position detection unit 52 matches the boarding waiting area of the elevator specified by the elevator specifying unit 61, and the number display unit 64 displays the number assigned by the number assignment unit 53 on the floor surface when the area matching determining unit 63 determines that the areas match, and displays the elevator number of the elevator specified by the elevator specifying unit 61 on the floor surface when the area matching determining unit 63 determines that the areas do not match. Therefore, similarly to the passenger guidance device illustrated in FIGS. 1 and 12, the passenger guidance device can allow the passenger 40 waiting for the arrival of the elevator to recognize the boarding order to the elevator, and can also allow the passenger 40 to be guided to the boarding waiting area of the elevator which the passenger 40 is to board.

In the passenger guidance device illustrated in FIG. 21, similarly to the number display unit 16 illustrated in the second embodiment, the number display unit 64 may display, in addition to the number assigned by the number assignment unit 53, guidance information prompting movement of the passenger 40 from the position in the boarding waiting area 2-1 detected by the position detection unit 52 to the entrance door 1-1 of the elevator on the floor surface in animation.

In addition, the number display unit 64 may display guidance information prompting movement of the passenger 40 from the position in the boarding waiting area 2-2 detected by the position detection unit 52 to the entrance door 1-2 of the elevator on the floor surface in animation.

### Sixth Embodiment

In the sixth embodiment, a description will be given of a passenger guidance device that, when the passenger 40 detected by the passenger detection unit 51 could not board the elevator specified by the elevator specifying unit 61, re-specifies an elevator which the passenger 40 who could not board is to board among the plurality of elevators on the basis of the registered destination floor.

In the sixth embodiment, it is assumed that two elevators are installed in order to simplify the description.

FIG. 24 is a configuration diagram illustrating a passenger guidance device according to the sixth embodiment. In FIG. 24, the same reference symbols as those in FIGS. 1, 12, 18, and 21 denote the same or corresponding parts, and thus description thereof is omitted.

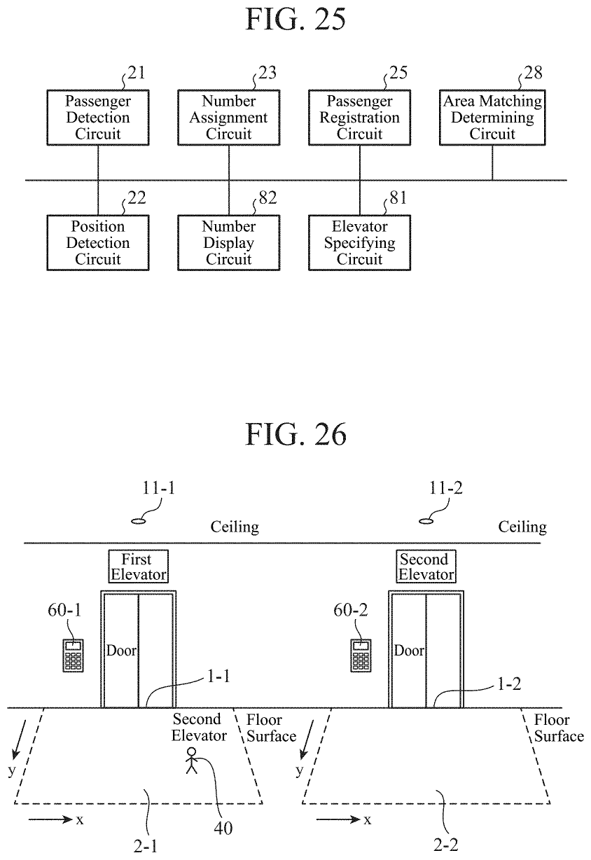

FIG. 25 is a hardware configuration diagram illustrating hardware of a signal processing unit 12 in the passenger guidance device according to the sixth embodiment. In FIG. 24, the same reference symbols as those in FIGS. 2, 19, and 22 denote the same or corresponding parts, and thus description thereof is omitted.

FIG. 26 is an explanatory diagram illustrating entrance doors 1-1 and 1-2 of two elevators and boarding waiting areas 2-1 and 2-2 of two elevators. In FIG. 26, the same reference symbols as those in FIGS. 13, 20, and 23 denote the same or corresponding parts, and thus description thereof is omitted.

The elevator specifying unit 65 is implemented by, for example, an elevator specifying circuit 81 illustrated in FIG. 25.

The elevator specifying unit 65 registers the destination floor indicated by the registration information of the destination floor output from either the destination floor registering operation panel 60-1 or the destination floor registering operation panel 60-2 in the passenger registration unit 55 so as to correspond to the ID included in the detection signal K_{ID, AREA}.

Similarly to the elevator specifying unit 61 illustrated in FIG. 18, the elevator specifying unit 65 specifies an elevator which the passenger 40 detected by the passenger detection unit 51 is to board among the plurality of elevators on the basis of the destination floor indicated by the registration information of the destination floor output from either the destination floor registering operation panel 60-1 or the destination floor registering operation panel 60-2.

If the passenger 40 detected by the passenger detection unit 51 could not board the specified elevator, the elevator specifying unit 65 re-specifies an elevator which the passenger 40 who could not board is to board among the plurality of elevators on the basis of the registered destination floor.

The number display unit 66 is implemented by, for example, a number display circuit 82 illustrated in FIG. 25.

The number display unit 66 generates display data similarly to the number display unit 62 illustrated in FIG. 18 or the number display unit 64 illustrated in FIG. 21.

In addition, when the elevator which the passenger 40 is to board is re-specified by the elevator specifying unit 65, the number display unit 66 generates display data for displaying the elevator number of the elevator re-specified by the elevator specifying unit 65 on the floor surface around the passenger 40.

In FIG. 24, it is assumed that each of the passenger detection unit 51, the position detection unit 52, the number assignment unit 53, the elevator specifying unit 65, the area matching determining unit 63, the number display unit 66, and the passenger registration unit 55, which are components of the signal processing unit 12, is implemented by dedicated hardware as illustrated in FIG. 25. That is, it is assumed that the signal processing unit 12 is implemented by the passenger detection circuit 21, the position detection circuit 22, the number assignment circuit 23, the elevator specifying circuit 81, the area matching determining circuit 28, the number display circuit 82, and the passenger registration circuit 25.

Here, each of the elevator specifying circuit 81 and the number display circuit 82 corresponds to, for example, a single circuit, a composite circuit, a programmed processor, a parallel programmed processor, ASIC, FPGA, or a combination thereof.

The components of the signal processing unit 12 are not limited to those implemented by dedicated hardware, but the signal processing unit 12 may be implemented by software, firmware, or a combination of software and firmware.

Next, the operation of the passenger guidance device shown in FIG. 24 will be described.

Since the operation of the passenger guidance device other than the elevator specifying unit 65 and the number display unit 66 is similar to that of the passenger guidance device illustrated in FIGS. 12, 18, and 21, the operation of the elevator specifying unit 65 and the number display unit 66 will be mainly described here.

In addition, for convenience of description, it is assumed that, among the two elevators illustrated in FIG. 26, the elevator on the left side in the drawing is a first elevator, and the elevator on the right side in the drawing is a second elevator.

Upon receiving the registration information of the destination floor from either the destination floor registering operation panel 60-1 or the destination floor registering operation panel 60-2, the elevator specifying unit 65 registers the destination floor indicated by the registration information in the passenger registration unit 55 so as to correspond to the ID included in the detection signal K_{ID, AREA}.

When the elevator arrives, a control device (not illustrated) of the elevator outputs an arrival notification signal indicating that the elevator has arrived to the elevator specifying unit 65.

Upon receiving the arrival notification signal from the control device (not illustrated), the elevator specifying unit 65 recognizes that the elevator has arrived.

Here, the elevator specifying unit 65 recognizes that the elevator has arrived by receiving the arrival notification signal from the control device (not illustrated). However, this is merely an example, and the elevator specifying unit 65 may recognize that the elevator has arrived by detecting that the door of the elevator has been opened using a sensor or the like.

Even if the elevator arrives, if there is an ID remaining without being deleted in the passenger registration unit 55, the elevator specifying unit 65 recognizes that the passenger 40 having the ID is the passenger 40 who could not board the specified elevator.

The elevator specifying unit 65 acquires, from the passenger registration unit 55, the position of the passenger 40 associated with the ID that remains without being deleted and the destination floor of the passenger 40 associated with the ID.

The elevator specifying unit 65 re-specifies the elevator which the passenger 40 having the ID is to board among the plurality of elevators on the basis of the acquired destination floor.

The elevator specifying unit 65 outputs elevator re-specifying information indicating the re-specified elevator to the number display unit 66.

The elevator re-specifying information includes the position of the passenger 40 associated with the ID.

Upon receiving the elevator re-specifying information from the elevator specifying unit 65, the number display unit 66 generates display data for displaying the elevator number of the elevator which the passenger 40 having the ID is to board on the floor surface around the passenger 40 having the ID as illustrated in FIG. 26 in accordance with the elevator re-specifying information.

Upon receiving the display data from the number display unit 66, the display apparatus 18 displays the elevator number of the elevator which the passenger 40 is to board on the floor surface around the position detected by the position detection unit 52 in accordance with the display data.

In the example of FIG. 26, the display apparatus 18 displays “second elevator” as the elevator number of the elevator which the passenger 40 is to board on the floor surface around the position of the passenger 40.

In the sixth embodiment described above, the passenger guidance device is configured in such a manner that the elevator specifying unit 65 re-specifies the elevator which the passenger 40 detected by the passenger detection unit 51 is to board among the plurality of elevators on the basis of the registered destination floor when the passenger 40 detected by the passenger detection unit 51 could not board the specified elevator, and the number display unit 66 displays the elevator number of the elevator re-specified by the elevator specifying unit 65 on the floor surface. Therefore, similarly to the passenger guidance device illustrated in FIGS. 1 and 12, the passenger guidance device can allow the passenger 40 waiting for the arrival of the elevator to recognize the boarding order to the elevator, and can also allow the passenger 40 to be guided to the boarding waiting area of the elevator which the passenger 40 who could not board the elevator is to board.

### Seventh Embodiment

In the passenger guidance device of the first to sixth embodiments, the number display unit 16, 54, 62, 64, 66 (hereinafter referred to as “number display unit 16 or the like”) displays the number assigned by the number assignment unit 15, 53 (hereinafter referred to as “number assignment unit 15 or the like”) on the floor surface around the position of the passenger 40.

In the seventh embodiment, a passenger guidance device will be described in which the number display unit 16 or the like displays a number assigned by the number assignment unit 15 or the like on a floor surface around a position of the passenger 40, and also displays guidance information specifying a position where the passenger 40 detected by the passenger detection unit 13, 51 (hereinafter referred to as “passenger detection unit 13 or the like”) should wait on the floor surface.

The configuration diagram illustrating the passenger guidance device of the seventh embodiment is similar to the configuration diagram illustrating the passenger guidance device of any one of the first to sixth embodiments.

The number display unit 16 or the like of the seventh embodiment generates display data for displaying the number assigned by the number assignment unit 15 or the like on the floor surface around the position of the passenger 40, similarly to the number display unit 16 or the like of the first to sixth embodiments.

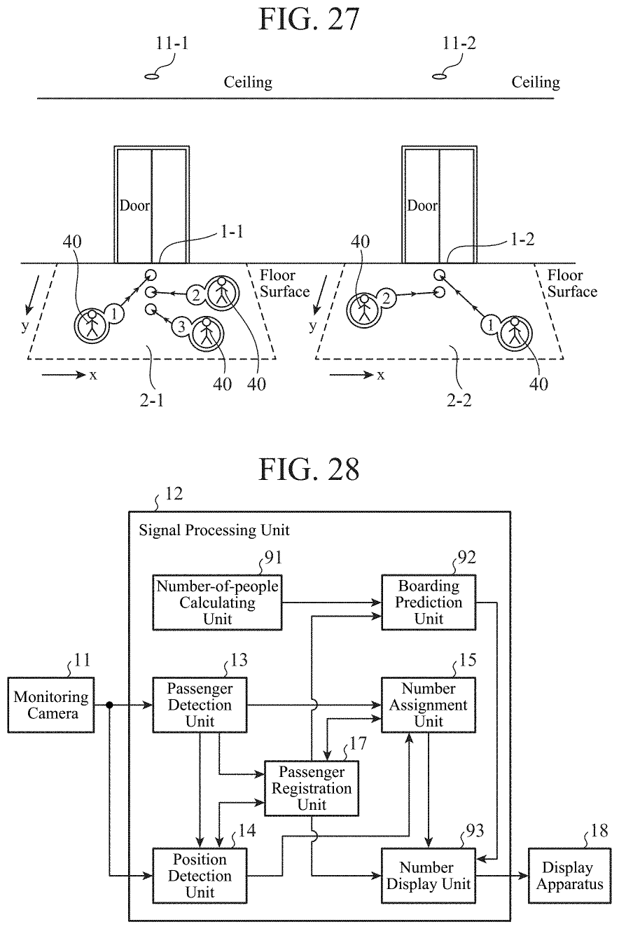

As illustrated in FIG. 27, the number display unit 16 or the like of the seventh embodiment generates display data for displaying, on the floor surface, guidance information specifying a position where the passenger 40 detected by the passenger detection unit 13 or the like should wait.

FIG. 27 is an explanatory diagram illustrating guidance information displayed on the floor surface around the position of the passenger 40.

The number display unit 16 or the like of the seventh embodiment outputs the generated display data to the display apparatus 18.

Upon receiving the display data from the number display unit 16 or the like, the display apparatus 18 displays the number assigned by the number assignment unit 15 or the like on the floor surface around the position detected by the position detection unit 14, 52 in accordance with the display data.

In addition, the display apparatus 18 displays, on the floor surface, guidance information specifying a position where the passenger 40 should wait in accordance with the display data.

In the example of FIG. 27, the display apparatus 18 displays, on the floor surface, guidance information specifying positions where three passengers 40 should wait so that the three passengers 40 present in the boarding waiting area 2-1 are arranged in the boarding order.

Further, in the example of FIG. 27, the display apparatus 18 displays, on the floor surface, guidance information specifying positions where two passengers 40 wait so that the two passengers 40 present in the boarding waiting area 2-2 are arranged in the boarding order.

In the above-described seventh embodiment, the passenger guidance device is configured in such a manner that the number display unit 16 or the like displays the number assigned by the number assignment unit 15 or the like on the floor surface around the position of the passenger 40 and displays guidance information specifying the position where the passenger 40 detected by the passenger detection unit 13 or the like should wait on the floor surface. Therefore, similarly to the passenger guidance device of the first to sixth embodiments, the passenger guidance device can allow the passenger 40 waiting for the arrival of the elevator to recognize the boarding order to the elevator, and can allow the passenger 40 to board the elevator in the boarding order.

### Eighth Embodiment

In the eighth embodiment, a description will be given of a passenger guidance device that predicts which round of the elevator each passenger 40 detected by the passenger detection unit 13 can board and displays a round indicating a prediction result on a floor surface around the passenger 40.

In the eighth embodiment, a passenger guidance device applicable to one elevator is described for simplification of description, but a passenger guidance device applicable to a plurality of elevators may be used.

FIG. 28 is a configuration diagram illustrating a passenger guidance device according to the eighth embodiment. In FIG. 28, the same reference symbols as those in FIG. 1 denote the same or corresponding parts, and thus description thereof is omitted.

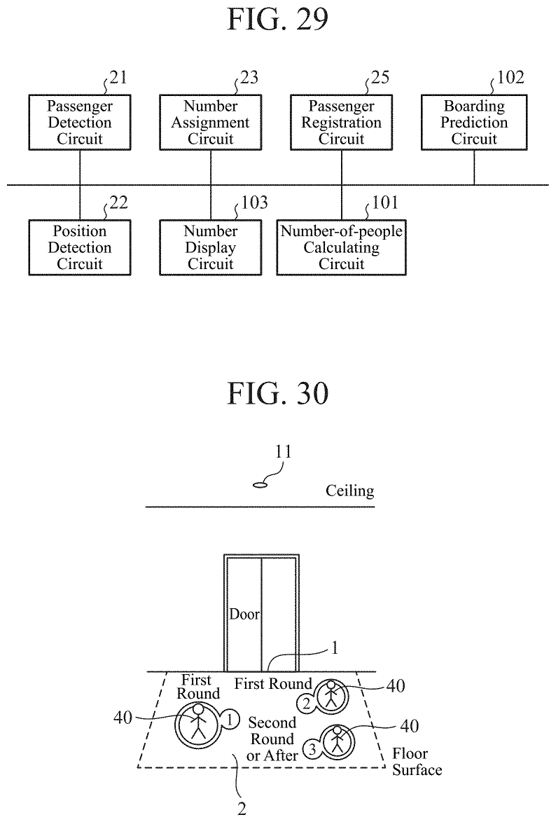

FIG. 29 is a hardware configuration diagram illustrating hardware of a signal processing unit 12 in the passenger guidance device according to the eighth embodiment. In FIG. 29, the same reference symbols as those in FIG. 2 denote the same or corresponding parts, and thus description thereof is omitted.

A number-of-people calculating unit 91 is implemented by, for example, a number-of-people calculating circuit 101 illustrated in FIG. 29.

The number-of-people calculating unit 91 calculates the number of people who can board the elevator on the basis of the number of passengers boarding the elevator.

A boarding prediction unit 92 is implemented by, for example, a boarding prediction circuit 102 illustrated in FIG. 29.

The boarding prediction unit 92 predicts which round of the elevator each passenger 40 detected by the passenger detection unit 13 can board on the basis of the number of people calculated by the number-of-people calculating unit 91 and the number of passengers 40 present in the boarding waiting area 2.

For example, the elevator of the first round corresponds to the elevator that first arrives at the floor where the passenger 40 is present from the time when the passenger 40 has entered the boarding waiting area 2.

The elevator of the second round corresponds to the elevator of the second arrival at the floor where the passenger 40 is present from the time when the passenger 40 has entered the boarding waiting area 2.

A number display unit 93 is implemented by, for example, a number display circuit 103 illustrated in FIG. 29.

Similarly to the number display unit 16 illustrated in FIG. 1, the number display unit 93 acquires the assignment number associated with the ID registered in the passenger registration unit 17 and the position associated with the ID registered in the passenger registration unit 17.

Similarly to the number display unit 16 illustrated in FIG. 1, the number display unit 93 generates display data for displaying the assignment number associated with the ID on the floor surface around the position associated with the ID.

In addition, the number display unit 93 generates display data for displaying the round indicating the prediction result of the boarding prediction unit 92 on the floor surface around the position associated with the ID.

The number display unit 93 outputs the generated display data to the display apparatus 18.

In FIG. 28, it is assumed that each of the passenger detection unit 13, the position detection unit 14, the number assignment unit 15, the number-of-people calculating unit 91, the boarding prediction unit 92, the number display unit 93, and the passenger registration unit 17, which are components of the signal processing unit 12, is implemented by dedicated hardware as illustrated in FIG. 29. That is, it is assumed that the signal processing unit 12 is implemented by the passenger detection circuit 21, the position detection circuit 22, the number assignment circuit 23, the number-of-people calculating circuit 101, the boarding prediction circuit 102, the number display circuit 103, and the passenger registration circuit 25.

Here, each of the number-of-people calculating circuit 101, the boarding prediction circuit 102, and the number display circuit 103 corresponds to, for example, a single circuit, a composite circuit, a programmed processor, a parallel-programmed processor, ASIC, FPGA, or a combination thereof.

The components of the signal processing unit 12 are not limited to those implemented by dedicated hardware, but the signal processing unit 12 may be implemented by software, firmware, or a combination of software and firmware.

Next, the operation of the passenger guidance device illustrated in FIG. 28 will be described.

Since the operation of the passenger guidance device other than the number-of-people calculating unit 91, the boarding prediction unit 92, and the number display unit 93 is similar to that of the passenger guidance device illustrated in FIG. 1, the operation of the number-of-people calculating unit 91, the boarding prediction unit 92, and the number display unit 93 will be mainly described here.

A control device (not illustrated) of the elevator measures the number of passengers boarding the elevator, for example, by analyzing a video of a camera monitoring the inside of the elevator.

The control device (not illustrated) outputs measurement information of the number of people to the number-of-people calculating unit 91 of the signal processing unit 12.

Here, the control device (not illustrated) measures the number of passengers boarding the elevator by analyzing the video of the camera. However, this is merely an example, and the control device (not illustrated) may calculate a ratio of the current loading amount of the elevator to the maximum loading amount of the elevator and estimate the number of passengers boarding the elevator on the basis of the calculated ratio.

Upon receiving the measurement information of the number of people from the control device (not illustrated), the number-of-people calculating unit 91 calculates the number of people who can board the elevator by subtracting the number of people indicated by the measurement information from the maximum number of people who can board the elevator.

The number-of-people calculating unit 91 outputs number-of-people information indicating the calculated number of people to the boarding prediction unit 92.

In the passenger guidance device illustrated in FIG. 28, the number-of-people calculating unit 91 calculates the number of people who can board the elevator by subtracting the number of people indicated by the measurement information from the maximum number of people who can board the elevator. However, this is merely an example, and if the passenger boarding the elevator has registered the destination floor, the number-of-people calculating unit 91 may calculate the number of people who can board the elevator by specifying the number of passengers remaining in the arriving elevator without getting off from the arriving elevator on the basis of the registration information of the destination floor.

The boarding prediction unit 92 recognizes the number of passengers 40 present in the boarding waiting area 2 by counting the number of IDs registered in the passenger registration unit 17.

Upon receiving the number-of-people information from the number-of-people calculating unit 91, the boarding prediction unit 92 compares the number of people indicated by the number-of-people information with the number of passengers 40 present in the boarding waiting area 2.

If the number of passengers 40 present in the boarding waiting area 2 is equal to or smaller than the number of people indicated by the number-of-people information, the boarding prediction unit 92 predicts that all the passengers 40 present in the boarding waiting area 2 can board the elevator of the first round.

If the number of passengers 40 present in the boarding waiting area 2 is larger than the number of people indicated by the number-of-people information, the boarding prediction unit 92 predicts that the number of passengers 40 corresponding to the number of people indicated by the number-of-people information among the plurality of passengers 40 present in the boarding waiting area 2 can board the elevator of the first round.

The passengers 40 who can board the elevator of the first round are the passenger 40 whose boarding order is the first to the passenger 40 whose number of people is indicated by the number-of-people information among the plurality of passengers 40 present in the boarding waiting area 2.

The boarding prediction unit 92 predicts that the passengers 40 other than the passengers 40 predicted to be able to board the elevator of the first round among the plurality of passengers 40 present in the boarding waiting area 2 can board the elevators of the second and subsequent rounds. The second and subsequent rounds include the second round.

The boarding prediction unit 92 outputs, to the number display unit 93, a prediction result indicating which round of the elevator each passenger 40 detected by the passenger detection unit 13 can board.

Similarly to the number display unit 16 illustrated in FIG. 1, the number display unit 93 acquires the assignment number associated with the ID registered in the passenger registration unit 17 and the position associated with the ID registered in the passenger registration unit 17.

Similarly to the number display unit 16 illustrated in FIG. 1, the number display unit 93 generates display data for displaying the assignment number associated with the ID on the floor surface around the position associated with the ID.

Further, upon receiving the prediction result from the boarding prediction unit 92, the number display unit 93 generates display data for displaying the round indicated by the prediction result on the floor surface around the position associated with the ID as illustrated in FIG. 30.

FIG. 30 is an explanatory view illustrating a round displayed on a floor surface around a position of the passenger 40.

The number display unit 93 outputs the generated display data to the display apparatus 18.

Upon receiving the display data from the number display unit 93, the display apparatus 18 displays the assignment number on the floor surface around the position detected by the position detection unit 52 in accordance with the display data.

Further, the display apparatus 18 displays a round indicating the prediction result on the floor surface around the position of passenger 40 detected by position detection unit 52 in accordance with the display data.

In the example of FIG. 30, three passengers 40 are present in the boarding waiting area 2, and the number of people who can board the elevator is two, and thus, the display apparatus 18 displays “first round” on the floor surface around the positions of the first and second passengers 40 in the boarding order.

Further, the display apparatus 18 displays “second round or after” on the floor surface around the position of the passenger 40 whose boarding order is the third.

In the passenger guidance device illustrated in FIG. 28, the display apparatus 18 displays a round indicated by the prediction result on the floor surface around the position of passenger 40 detected by position detection unit 52. However, this is merely an example, and the display apparatus 18 may display, for example, an animation indicating the round number.

In the eighth embodiment described above, the passenger guidance device is configured in such a manner that it includes the number-of-people calculating unit 91 for calculating the number of people who can board the elevator on the basis of the number of passengers boarding the elevator, and the boarding prediction unit 92 for predicting which round of the elevator each of the passengers 40 detected by the passenger detection unit 13 can board on the basis of the number of people calculated by the number-of-people calculating unit 91 and the number of passengers 40 present in the boarding waiting area 2, and the number display unit 93 displays, in addition to the number assigned by the number assignment unit 15, the round indicated by the prediction result of the boarding prediction unit 92 on the floor surface. Therefore, similarly to the passenger guidance device of the first to seventh embodiments, the passenger guidance device can allow the passenger 40 waiting for the arrival of the elevator to recognize the boarding order to the elevator, and can allow the passenger 40 to recognize which round of the elevator the passenger 40 can board.

### Ninth Embodiment

In the ninth embodiment, a passenger guidance device including a towing determination unit 94 for determining whether or not a passenger 40 detected by a passenger detection unit 13 tows a movable object will be described.

In the ninth embodiment, for simplification of description, a passenger guidance device applicable to one elevator is described, but a passenger guidance device applicable to a plurality of elevators may be used.

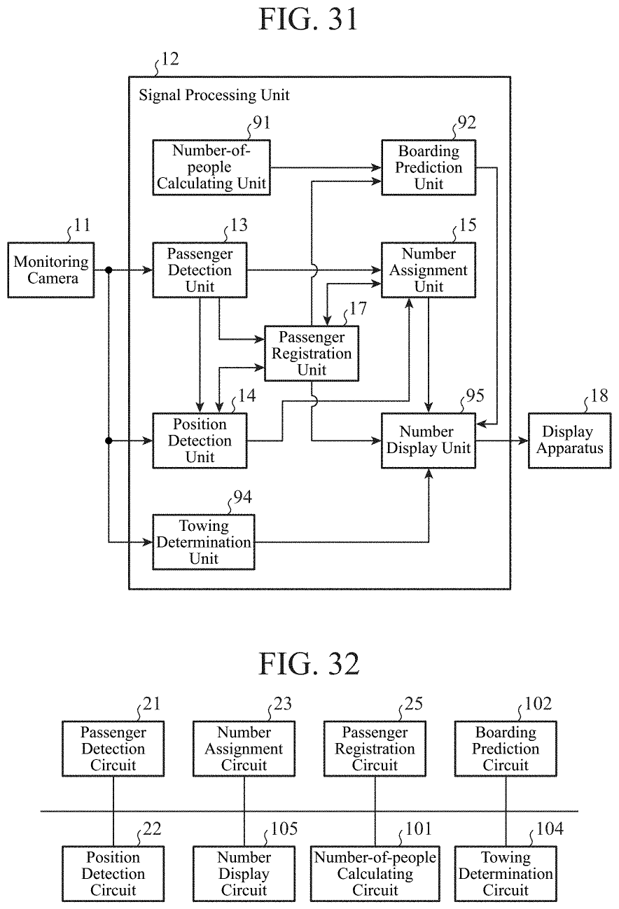

FIG. 31 is a configuration diagram illustrating a passenger guidance device according to the ninth embodiment. In FIG. 31, the same reference symbols as those in FIGS. 1 and 28 denote the same or corresponding parts, and thus description thereof is omitted.

FIG. 32 is a hardware configuration diagram illustrating hardware of a signal processing unit 12 in the passenger guidance device according to the ninth embodiment. In FIG. 32, the same reference symbols as those in FIGS. 2 and 29 denote the same or corresponding parts, and thus description thereof is omitted.

The towing determination unit 94 is implemented by, for example, a towing determination circuit 104 illustrated in FIG. 32.

The towing determination unit 94 analyzes the image data output from the monitoring camera 11 to determine whether or not the passenger 40 detected by the passenger detection unit 13 tows a movable object. The movable object corresponds to a shopping cart, a baby carriage, or the like.

The number display unit 95 is implemented by, for example, a number display circuit 105 illustrated in FIG. 32.

Similarly to the number display unit 16 illustrated in FIG. 1 or the number display unit 93 illustrated in FIG. 28, the number display unit 95 acquires the assignment number associated with the ID registered in the passenger registration unit 17 and the position associated with the ID registered in the passenger registration unit 17.

Similarly to the number display unit 16 illustrated in FIG. 1 or the number display unit 93 illustrated in FIG. 28, the number display unit 95 generates display data for displaying the assignment number associated with the ID on the floor surface around the position associated with the ID.

In addition, when the towing determination unit 94 determines that towing is performed, the number display unit 95 generates display data for displaying an area including both the passenger 40 and the movable object on the floor surface as a personal space.

In FIG. 31, each of the passenger detection unit 13, the position detection unit 14, the number assignment unit 15, the number-of-people calculating unit 91, the boarding prediction unit 92, the towing determination unit 94, the number display unit 95, and the passenger registration unit 17, which are components of the signal processing unit 12, is assumed to be implemented by dedicated hardware as illustrated in FIG. 32. That is, it is assumed that the signal processing unit 12 is implemented by the passenger detection circuit 21, the position detection circuit 22, the number assignment circuit 23, the number-of-people calculating circuit 101, the boarding prediction circuit 102, the towing determination circuit 104, the number display circuit 105, and the passenger registration circuit 25.

Here, each of the towing determination circuit 104 and the number display circuit 105 corresponds to, for example, a single circuit, a composite circuit, a programmed processor, a parallel programmed processor, ASIC, FPGA, or a combination thereof.

The components of the signal processing unit 12 are not limited to those implemented by dedicated hardware, but the signal processing unit 12 may be implemented by software, firmware, or a combination of software and firmware.

Next, the operation of the passenger guidance device shown in FIG. 31 will be described.

Since the operation of the passenger guidance device other than the towing determination unit 94 and the number display unit 95 is similar to that of the passenger guidance device illustrated in FIG. 1 or the passenger guidance device illustrated in FIG. 28, the operation of the towing determination unit 94 and the number display unit 95 will be mainly described here.

The towing determination unit 94 analyzes the image data output from the monitoring camera 11 to determine whether or not the passenger 40 detected by the passenger detection unit 13 tows a movable object.

The process of analyzing the image data and determining whether or not the passenger 40 tows the movable object is a known technique, and thus a detailed description thereof will be omitted.

The towing determination unit 94 outputs a determination result indicating whether or not the passenger 40 tows the movable object to the number display unit 95.

Similarly to the number display unit 16 illustrated in FIG. 1 or the number display unit 93 illustrated in FIG. 28, the number display unit 95 acquires the assignment number associated with the ID registered in the passenger registration unit 17 and the position associated with the ID registered in the passenger registration unit 17.

Similarly to the number display unit 16 illustrated in FIG. 1 or the number display unit 93 illustrated in FIG. 28, the number display unit 95 generates display data for displaying the assignment number associated with the ID on the floor surface around the position associated with the ID.

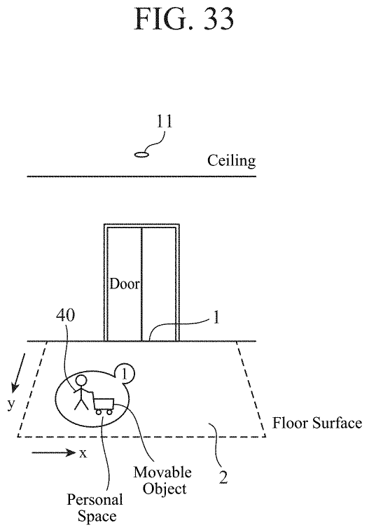

In addition, when the determination result output from the towing determination unit 94 indicates that the passenger 40 tows the movable object, the number display unit 95 generates display data for displaying an area including both the passenger 40 and the movable object as a personal space on the floor surface as illustrated in FIG. 33.

FIG. 33 is an explanatory view showing that the area including both the passenger 40 and the movable object is a personal space.

The number display unit 95 outputs the generated display data to the display apparatus 18.

Upon receiving the display data from the number display unit 95, the display apparatus 18 displays the assignment number on the floor surface around the position detected by the position detection unit 52 in accordance with the display data.

Further, as illustrated in FIG. 33, the display apparatus 18 displays the area including both the passenger 40 and the movable object as the personal space in accordance with the display data.

In the example of FIG. 33, the inside of ◯ surrounding both the passenger 40 and the movable object is a personal space.

The size of ◯ surrounding both the passenger 40 and the movable object is larger than the size of ◯ surrounding the passenger 40 illustrated in FIG. 10, for example.

In the ninth embodiment described above, the passenger guidance device is configured in such a manner that it includes the towing determination unit 94 for determining whether or not the passenger 40 detected by the passenger detection unit 13 tows the movable object, and the number display unit 95 displays the area including both the passenger 40 and the movable object on the floor surface as the personal space when the towing determination unit 94 determines that the passenger 40 tows the movable object. Therefore, similarly to the passenger guidance device of the first to eighth embodiments, the passenger guidance device of the ninth embodiment can allow the passenger 40 who waits for the arrival of the elevator to recognize the boarding order to the elevator, and can enhance each of the safety and the comfort of the waiting passenger 40 as compared with the passenger guidance device of the first to eighth embodiments.

### Tenth Embodiment

In the tenth embodiment, a passenger guidance device including a boarding determination unit 96 for determining whether or not a passenger 40 detected by a passenger detection unit 13 is on a movable object will be described.

In the tenth embodiment, for simplification of description, a passenger guidance device applicable to one elevator is described, but a passenger guidance device applicable to a plurality of elevators may be used.

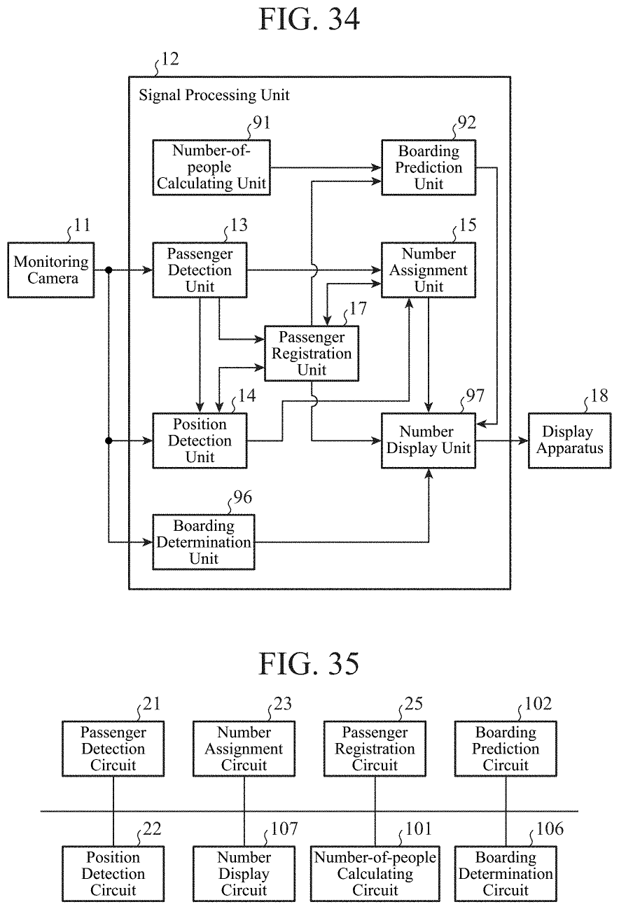

FIG. 34 is a configuration diagram illustrating a passenger guidance device according to the tenth embodiment. In FIG. 34, the same reference symbols as those in FIGS. 1 and 28 denote the same or corresponding parts, and thus description thereof is omitted.

FIG. 35 is a hardware configuration diagram illustrating hardware of a signal processing unit 12 in the passenger guidance device according to the tenth embodiment. In FIG. 35, the same reference symbols as those in FIGS. 2 and 29 denote the same or corresponding parts, and thus description thereof is omitted.

The boarding determination unit 96 is implemented by, for example, a boarding determination circuit 106 illustrated in FIG. 35.

The boarding determination unit 96 analyzes the image data output from the monitoring camera 11 to determine whether or not the passenger 40 detected by the passenger detection unit 13 is on the movable object. The movable object corresponds to, for example, a wheelchair.

The number display unit 97 is implemented by, for example, a number display circuit 107 illustrated in FIG. 35.

Similarly to the number display unit 16 illustrated in FIG. 1 or the number display unit 93 illustrated in FIG. 28, the number display unit 97 acquires the assignment number associated with the ID registered in the passenger registration unit 17 and the position associated with the ID registered in the passenger registration unit 17.

Similarly to the number display unit 16 illustrated in FIG. 1 or the number display unit 93 illustrated in FIG. 28, the number display unit 97 generates display data for displaying the assignment number associated with the ID on the floor surface around the position associated with the ID.

Further, when the boarding determination unit 96 determines that the passenger 40 is on the movable object, the number display unit 97 generates display data for displaying an area including the movable object as a personal space on the floor surface.

In FIG. 34, it is assumed that each of the passenger detection unit 13, the position detection unit 14, the number assignment unit 15, the number-of-people calculating unit 91, the boarding prediction unit 92, the boarding determination unit 96, the number display unit 97, and the passenger registration unit 17, which are components of the signal processing unit 12, is implemented by dedicated hardware as illustrated in FIG. 35. That is, it is assumed that the signal processing unit 12 is implemented by the passenger detection circuit 21, the position detection circuit 22, the number assignment circuit 23, the number-of-people calculating circuit 101, the boarding prediction circuit 102, the boarding determination circuit 106, the number display circuit 107, and the passenger registration circuit 25.

Here, each of the boarding determination circuit 106 and the number display circuit 107 corresponds to, for example, a single circuit, a composite circuit, a programmed processor, a parallel-programmed processor, ASIC, FPGA, or a combination thereof.

The components of the signal processing unit 12 are not limited to those implemented by dedicated hardware, but the signal processing unit 12 may be implemented by software, firmware, or a combination of software and firmware.

Next, the operation of the passenger guidance device shown in FIG. 34 will be described.

Since the operation of the passenger guidance device other than the boarding determination unit 96 and the number display unit 97 is similar to that of the passenger guidance device illustrated in FIG. 1 or the passenger guidance device illustrated in FIG. 28, the operation of the boarding determination unit 96 and the number display unit 97 will be mainly described here.

The boarding determination unit 96 analyzes the image data output from the monitoring camera 11 to determine whether or not the passenger 40 detected by the passenger detection unit 13 is on the movable object.

The process itself of analyzing the image data to determine whether or not the passenger 40 is on the movable object is a known technique, and thus a detailed description thereof will be omitted.

The boarding determination unit 96 outputs a determination result indicating whether or not the passenger 40 is on the movable object to the number display unit 97.

Similarly to the number display unit 16 illustrated in FIG. 1 or the number display unit 93 illustrated in FIG. 28, the number display unit 97 acquires the assignment number associated with the ID registered in the passenger registration unit 17 and the position associated with the ID registered in the passenger registration unit 17.

Similarly to the number display unit 16 illustrated in FIG. 1 or the number display unit 93 illustrated in FIG. 28, the number display unit 97 generates display data for displaying the assignment number associated with the ID on the floor surface around the position associated with the ID.

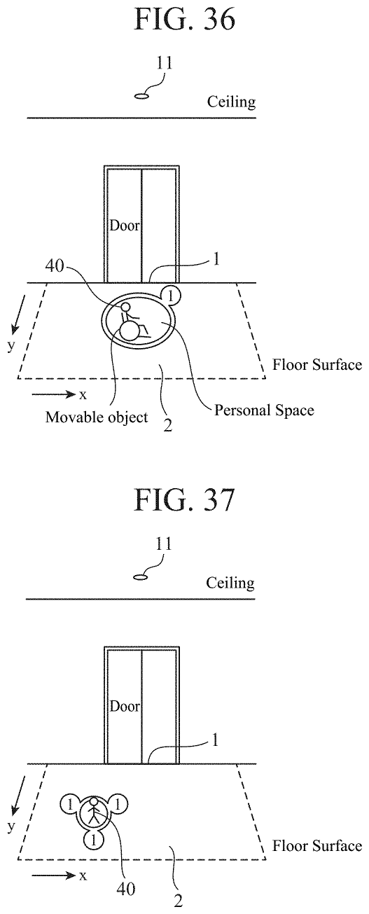

Further, when the determination result output from the boarding determination unit 96 indicates that the passenger 40 is on the movable object, as shown in FIG. 36, the number display unit 97 generates display data for displaying an area including the movable object as a personal space on the floor surface.

FIG. 36 is an explanatory view showing that an area including the movable object is a personal space.

The number display unit 97 outputs the generated display data to the display apparatus 18.

Upon receiving the display data from the number display unit 97, the display apparatus 18 displays the assignment number on the floor surface around the position detected by the position detection unit 52 in accordance with the display data.

In addition, the display apparatus 18 displays the area including the movable object as the personal space as illustrated in FIG. 36 in accordance with the display data.

In the example of FIG. 36, the inside of ◯ surrounding the movable object is the personal space.

The size of ◯ surrounding the movable object is larger than the size of ◯ surrounding the passenger 40 illustrated in FIG. 10, for example.

In the above-described tenth embodiment, the passenger guidance device is configured in such a manner that it includes the boarding determination unit 96 for determining whether or not the passenger 40 detected by the passenger detection unit 13 is on the movable object, and the number display unit 97 displays the area including the movable object as the personal space on the floor surface when the boarding determination unit 96 determines that the passenger 40 is on the movable object. Therefore, similarly to the passenger guidance device of the first to eighth embodiments, the passenger guidance device of the tenth embodiment can allow the passenger 40 waiting for arrival of the elevator to recognize the boarding order to the elevator, and can enhance each of the safety and the comfort of the waiting passenger 40 as compared with the passenger guidance device of the first to eighth embodiments.

### Eleventh Embodiment

In the passenger guidance device of the first embodiment, the number display unit 16 displays the number assigned by the number assignment unit 15 on the floor surface around the position detected by the position detection unit 14.

In the eleventh embodiment, a passenger guidance device will be described in which the number display unit 16 displays the number assigned by the number assignment unit 15 at a plurality of locations on the floor surface around the position detected by the position detection unit 14.

A configuration diagram illustrating a passenger guidance device of the eleventh embodiment is illustrated in FIG. 1 similarly to the passenger guidance device of the first embodiment.

As illustrated in FIG. 37, the number display unit 16 of the eleventh embodiment generates display data for displaying the number assigned by the number assignment unit 15 at a plurality of locations on the floor surface around the position detected by the position detection unit 14.

The number display unit 16 of the eleventh embodiment outputs the generated display data to the display apparatus 18.

The display apparatus 18 displays the number assigned by the number assignment unit 15 at a plurality of locations on the floor surface around the position detected by the position detection unit 14 in accordance with the display data output from the number display unit 16.

FIG. 37 is an explanatory diagram illustrating assignment numbers displayed at a plurality of locations on the floor surface around the position of passenger 40.

In the example of FIG. 37, the display apparatus 18 displays the numbers “1” assigned by the number assignment unit 15 at three locations on the floor surface around the position detected by the position detection unit 14.

In the above-described eleventh embodiment, the passenger guidance device is configured in such a manner that the number display unit 16 displays the number assigned by the number assignment unit 15 at a plurality of locations on the floor surface around the position detected by the position detection unit 14. Therefore, similarly to the passenger guidance device illustrated in FIG. 1, the passenger guidance device can allow the passenger 40 waiting for the arrival of the elevator to recognize the boarding order to the elevator, and can make it easier for the passenger 40 present in the boarding waiting area 2 to notify another passenger 40 of the boarding order than the passenger guidance device illustrated in FIG. 1.

### Twelfth Embodiment

In the passenger guidance device of the first embodiment, the number display unit 16 displays the number assigned by the number assignment unit 15 on the floor surface around the position detected by the position detection unit 14.

In the twelfth embodiment, a passenger guidance device will be described in which the number display unit 16 moves the display position of the number assigned by the number assignment unit 15.

A configuration diagram illustrating a passenger guidance device of the twelfth embodiment is illustrated in FIG. 1 similarly to the passenger guidance device of the first embodiment.

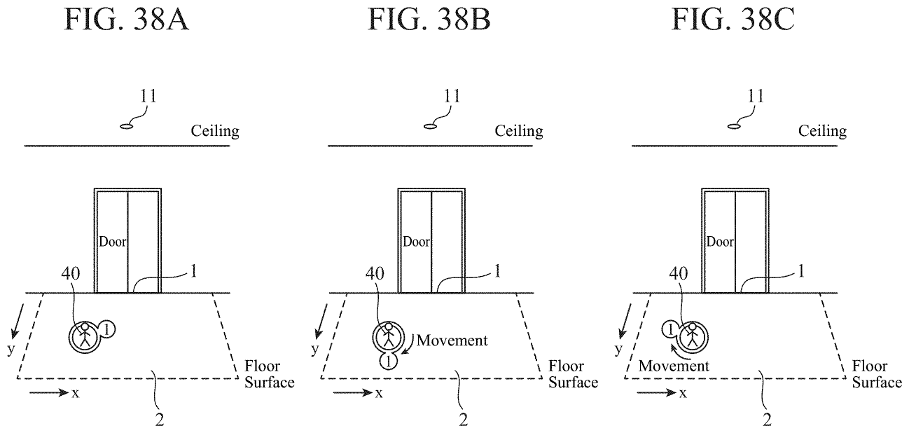

As illustrated in FIG. 38, the number display unit 16 of the twelfth embodiment generates display data for moving the display position of the number assigned by the number assignment unit 15.

The number display unit 16 of the twelfth embodiment outputs the generated display data to the display apparatus 18.

The display apparatus 18 displays the number assigned by the number assignment unit 15 on the floor surface around the position detected by the position detection unit 14 in accordance with the display data output from the number display unit 16.

In addition, the display apparatus 18 moves the display position of the number assigned by the number assignment unit 15 in accordance with the display data.

FIG. 38 is an explanatory diagram illustrating the assignment number the display position of which is moved by the number display unit 16.

In the example of FIG. 38, the display position of the assignment number moves with the lapse of time.

FIG. 38A illustrates the display position of the assignment number at time t₁.

FIG. 38B illustrates the display position of the assignment number at time t₁+t₀ after time to has elapsed from time t₁.

FIG. 38C illustrates the display position of the assignment number at time t₁+2t₀ after time to has elapsed from time t₁+t₀.

In the above-described twelfth embodiment, the passenger guidance device is configured in such a manner that the number display unit 16 moves the display position of the number assigned by the number assignment unit 15. Therefore, similarly to the passenger guidance device illustrated in FIG. 1, the passenger guidance device can allow the passenger 40 waiting for the arrival of the elevator to recognize the boarding order to the elevator, and can make it easier for the passenger 40 present in the boarding waiting area 2 to notify another passenger 40 of the boarding order than the passenger guidance device illustrated in FIG. 1.

### Thirteenth Embodiment

In the thirteenth embodiment, a passenger guidance device including a robot control unit 98 for controlling an operation of a robot when the passenger 40 detected by the passenger detection unit 13 is the robot will be described.

In the thirteenth embodiment, for simplification of description, a passenger guidance device applicable to one elevator is described, but a passenger guidance device applicable to a plurality of elevators may be used.

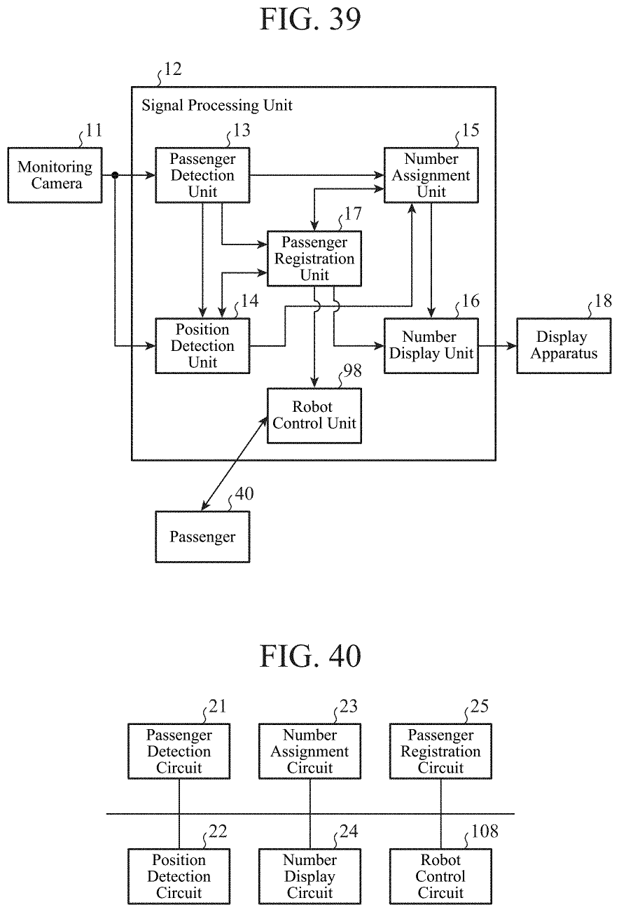

FIG. 39 is a configuration diagram illustrating a passenger guidance device according to the thirteenth embodiment. In FIG. 39, the same reference symbols as those in FIG. 1 denote the same or corresponding parts, and thus description thereof is omitted.

FIG. 40 is a hardware configuration diagram illustrating hardware of a signal processing unit 12 in the passenger guidance device according to the thirteenth embodiment. In FIG. 40, the same reference symbols as those in FIG. 2 denote the same or corresponding parts, and thus description thereof is omitted.

The robot control unit 98 is implemented by, for example, a robot control circuit 108 illustrated in FIG. 40.

If the passenger 40 detected by the passenger detection unit 13 is a robot, the robot control unit 98 controls the operation of the robot.

The robot control unit 98 instructs the robot on the timing of boarding the elevator.

In FIG. 39, it is assumed that each of the passenger detection unit 13, the position detection unit 14, the number assignment unit 15, the number display unit 16, the passenger registration unit 17, and the robot control unit 98, which are components of the signal processing unit 12, is implemented by dedicated hardware as illustrated in FIG. 40. That is, it is assumed that the signal processing unit 12 is implemented by the passenger detection circuit 21, the position detection circuit 22, the number assignment circuit 23, the number display circuit 24, the passenger registration circuit 25, and the robot control circuit 108.

Here, the robot control circuit 108 corresponds to, for example, a single circuit, a composite circuit, a programmed processor, a parallel programmed processor, ASIC, FPGA, or a combination thereof.

The components of the signal processing unit 12 are not limited to those implemented by dedicated hardware, but the signal processing unit 12 may be implemented by software, firmware, or a combination of software and firmware.

Next, the operation of the passenger guidance device shown in FIG. 39 will be described.

The operation of the passenger guidance device other than the robot control unit 98 is similar to that of the passenger guidance device shown in FIG. 1, and thus, here, the operation of the robot control unit 98 will be mainly described.

When the passenger 40 is a robot, the robot outputs a robot signal indicating that the passenger 40 is a robot to the robot control unit 98.

Upon receiving the robot signal from the passenger 40 detected by the passenger detection unit 13, the robot control unit 98 recognizes that the passenger 40 detected by the passenger detection unit 13 is a robot.

In the passenger guidance device shown in FIG. 39, upon receiving the robot signal from the passenger 40 detected by the passenger detection unit 13, the robot control unit 98 recognizes that the passenger 40 is a robot. However, this is merely an example, and the robot control unit 98 may determine whether or not the passenger 40 is a robot by mounting an image sensor and performing known image recognition processing, for example.

When the elevator arrives, a control device (not illustrated) of the elevator outputs an arrival notification signal indicating that the elevator has arrived to the robot control unit 98.

Upon receiving the arrival notification signal from the control device (not illustrated), the robot control unit 98 recognizes that the elevator has arrived.

In the passenger guidance device shown in FIG. 39, the robot control unit 98 recognizes that the elevator has arrived by receiving the arrival notification signal from the control device (not shown). However, this is merely an example, and the robot control unit 98 may recognize that the elevator has arrived by detecting that the door of the elevator has been opened using a sensor or the like.

The robot control unit 98, when recognizing that the elevator has arrived, monitors the deletion status of the ID registered in the passenger registration unit 17, and determines whether or not the passenger 40 assigned with a number smaller by 1 than the number assigned to the robot has boarded the elevator.

The robot control unit 98, when determining that the passenger 40 to which a number smaller by 1 than the number assigned to the robot is assigned has boarded the elevator, outputs a boarding instruction signal for giving an instruction of boarding to the elevator to the robot.

Upon receiving the boarding instruction signal from the robot control unit 98, the robot moves to the entrance door 1 of the elevator and then boards the elevator.

In the thirteenth embodiment described above, the passenger guidance device is configured to include the robot control unit 98 for controlling the operation of the robot when the passenger 40 detected by the passenger detection unit 13 is the robot. Therefore, even if the passenger 40 detected by the passenger detection unit 13 is a robot, the passenger guidance device can allow the robot to board the elevator in the boarding order indicated by the number assigned by the number assignment unit 15.

In addition, the passenger guidance device of the thirteenth embodiment, regardless of whether the passenger 40 detected by the passenger detection unit 13 is a human or a robot, the number assignment unit 15 fairly assigns a number indicating a boarding order to the elevator. Therefore, even when a large number of passengers enter the boarding waiting area 2, the robot can board the elevator with the same priority as a human.

In the passenger guidance device shown in FIG. 39, the robot control unit 98 outputs a boarding instruction signal for giving an instruction of boarding to the elevator to the robot. However, this is merely an example, and the robot control unit 98 may notify the robot of the number assigned by the number assignment unit 15, and the robot may monitor the movement of the passenger 40 around the robot, determine the timing at which the robot boards the elevator, and start the movement to the elevator.

It should be noted that the invention of the present application can freely combine the embodiments, modify any constituent element of each embodiment, or omit any constituent element in each embodiment within the scope of the invention.

### INDUSTRIAL APPLICABILITY

The present invention is suitable for a passenger guidance device and a passenger guidance method for displaying a number indicating a boarding order to an elevator on a floor surface around a position of a passenger.

### REFERENCE SIGNS LIST

1, 1-1, 1-2: elevator entrance door, 2, 2-1, 2-2: boarding waiting area, 11, 11-1, 11-2: monitoring camera, 12: signal processing unit, 13: passenger detection unit, 14: position detection unit, 15: number assignment unit, 16: number display unit, 17: passenger registration unit, 18: display apparatus, 21: passenger detection circuit, 22: position detection circuit, 23: number assignment circuit, 24: number display circuit, 25: passenger registration circuit, 26: elevator specifying circuit, 27: number display circuit, 28: area matching determining circuit, 29: number display circuit, 31: memory, 32: processor, 40: passenger, 51: passenger detection unit, 52: position detection unit, 53: number assignment unit, 54: number display unit, 55: passenger registration unit, 60-1, 60-2: destination floor registering operation panel, 61: elevator specifying unit, 62: number display unit, 63: area matching determining unit, 64: number display unit, 65: elevator specifying unit, 66: number display unit, 81: elevator specifying circuit, 82: number display circuit, 91: number-of-people calculating unit, 92: boarding prediction unit, 93: number display unit, 94: towing determination unit, 95: number display unit, 96: boarding determination unit, 97: number display unit, 98: robot control unit, 101: number-of-people calculating circuit, 102: boarding prediction circuit, 103: number display circuit, 104: towing determination circuit, 105: number display circuit, 106: boarding determination circuit, 107: number display circuit, 108: robot control circuit

1. A passenger guidance device comprising processing circuitry
to detect a passenger who has entered a boarding waiting area which is an area in front of an entrance door of an elevator,
to detect a position of a passenger detected by the processing circuitry,
to assign a number indicating a boarding order to the elevator to a passenger detected by the processing circuitry every time the processing circuitry detects a passenger, and
to display the number assigned by the processing circuitry on a floor surface around the position detected by the processing circuitry.

2. The passenger guidance device according to claim 1, further comprising a monitoring camera capturing an image of an area including the boarding waiting area and outputting image data of the area including the boarding waiting area, wherein the processing circuitry further performs
to detect a passenger who has entered the boarding waiting area by analyzing the image data output from the monitoring camera, and
to detect a position of a passenger detected by the processing circuitry by analyzing the image data output from the monitoring camera.

3. The passenger guidance device according to claim 1, wherein every time an image data is output from the monitoring camera, the processing circuitry detects a position of a passenger after movement by analyzing the image data to perform tracking processing of a passenger detected by the processing circuitry.

4. The passenger guidance device according to claim 1, wherein the processing circuitry displays guidance information prompting movement of a passenger from a position detected by the processing circuitry to an entrance door of the elevator on a floor surface in animation.

5. The passenger guidance device according to claim 4, wherein when the processing circuitry detects a plurality of passengers, the processing circuitry displays the guidance information in order from the guidance information for a passenger with a smaller number assigned by the processing circuitry among the plurality of passengers.

6. The passenger guidance device according to claim 1, wherein
a plurality of elevators are installed, and a plurality of boarding waiting areas are respectively provided in front of entrance doors of the plurality of elevators,
the processing circuitry detects a passenger who has entered each of the plurality of boarding waiting areas and outputs area information indicating the boarding waiting area which a passenger has entered, and
every time a passenger is detected by the processing circuitry, the processing circuitry assigns a number indicating a boarding order to an elevator corresponding to a boarding waiting area indicated by the area information output by the processing circuitry to a passenger detected by the processing circuitry.

7. The passenger guidance device according to claim 6, wherein the processing circuitry further performs to specify, when a destination floor of a passenger detected by the processing circuitry is registered, an elevator which a passenger detected by the processing circuitry is to board among the plurality of elevators on a basis of the registered destination floor.

8. The passenger guidance device according to claim 7, wherein the processing circuitry displays, in addition to the number assigned by the processing circuitry, an elevator number of the elevator specified by the processing circuitry on the floor surface.

9. The passenger guidance device according to claim 7, wherein the processing circuitry further performs to determine whether or not a boarding waiting area including a position of a passenger detected by the processing circuitry matches a boarding waiting area of an elevator specified by the processing circuitry, wherein
the processing circuitry displays the number assigned by the processing circuitry on the floor surface when the processing circuitry determines that the areas match, and displays an elevator number of the elevator specified by the processing circuitry on the floor surface when the processing circuitry determines that the areas do not match.

10. The passenger guidance device according to claim 7, wherein when a passenger detected by the processing circuitry could not board the specified elevator, the processing circuitry re-specifies an elevator which a passenger detected by the processing circuitry is to board among the plurality of elevators on a basis of the registered destination floor, and
the processing circuitry displays an elevator number of the elevator re-specified by the processing circuitry on the floor surface.

11. The passenger guidance device according to claim 1, wherein the processing circuitry displays, in addition to the number assigned by the processing circuitry, guidance information specifying a position at which a passenger detected by the processing circuitry should wait on the floor surface.

12. The passenger guidance device according to claim 1, wherein the processing circuitry further performs:
to calculate the number of people who can board the elevator on a basis of the number of passengers boarding the elevator, and
to predict which round of the elevator each passenger detected by the processing circuitry can board on a basis of the number of people calculated by the processing circuitry and the number of passengers present in the boarding waiting area, wherein
the processing circuitry displays, in addition to the number assigned by the processing circuitry, a round indicating a prediction result of the processing circuitry on the floor surface.

13. The passenger guidance device according to claim 1, wherein the processing circuitry further performs to determine whether or not a passenger detected by the processing circuitry tows a movable object, wherein
when the processing circuitry determines that a passenger tows a movable object, the processing circuitry displays an area including both a passenger and the movable object as a personal space on the floor surface.

14. The passenger guidance device according to claim 1, wherein the processing circuitry further performs to determine whether or not a passenger detected by the processing circuitry is on a movable object, wherein
when the processing circuitry determines that a passenger is on the movable object, the processing circuitry displays an area including the movable object as a personal space on the floor surface.

15. The passenger guidance device according to claim 1, wherein the processing circuitry displays the number assigned by the processing circuitry at a plurality of locations on the floor surface around the position detected by processing circuitry.

16. The passenger guidance device according to claim 1, wherein the processing circuitry moves a display position of the number assigned by the processing circuitry.

17. The passenger guidance device according to claim 1, wherein the processing circuitry further performs to control an operation of a robot when a passenger detected by the processing circuitry is the robot.

18. The passenger guidance device according to claim 17, wherein the processing circuitry instructs the robot on a timing of boarding the elevator.

19. A passenger guidance method performed by processing circuitry comprising:
detecting a passenger who has entered a boarding waiting area which is an area in front of an entrance door of an elevator;
detecting a position of a passenger detected by the processing circuitry;
assigning a number indicating a boarding order to the elevator to a passenger detected by the processing circuitry every time the processing circuitry detects a passenger; and
displaying the number assigned by the processing circuitry on a floor surface around the position detected by the processing circuitry.
